(19) United States
(12) Patent Application Publication
(10) Pub. No.: US 2002/0035520 A1
(43) Pub. Date: Mar. 21, 2002

(54) Property rating and ranking system and method

(76) Inventor: Allan N. Weiss, Cambridge, MA (US)

Correspondence Address: David M. Mello, McDermott, Will & Emery, 28 State Street, Boston, MA, 02109, US

(21) Appl. No.: 09/919,110

(22) Filed: Jul. 31, 2001

Related U.S. Application Data
(60) Provisional application No. 60/222,517, filed on Aug. 2, 2000.
(60) Provisional application No. 60/222,400, filed on Aug. 2, 2000.
(60) Provisional application No. 60/222,391, filed on Aug. 2, 2000.
(60) Provisional application No. 60/222,515, filed on Aug. 2, 2000.
(60) Provisional application No. 60/222,401, filed on Aug. 2, 2000.
(60) Provisional application No. 60/222,399, filed on Aug. 2, 2000.
(60) Provisional application No. 60/222,452, filed on Aug. 2, 2000.
(60) Provisional application No. 60/222,514, filed on Aug. 2, 2000.
(60) Provisional application No. 60/222,453, filed on Aug. 2, 2000.
(60) Provisional application No. 60/222,397, filed on Aug. 2, 2000.
(60) Provisional application No. 60/222,493, filed on Aug. 2, 2000.
(60) Provisional application No. 60/222,516, filed on Aug. 2, 2000.
(60) Provisional application No. 60/222,513, filed on Aug. 2, 2000.
(60) Provisional application No. 60/231,928, filed on Sep. 11, 2000.

(51) Int. Cl. G06F 17/60

(52) U.S. Cl. 705/27; 705/26; 705/38

(57) ABSTRACT

A system and method is provided that includes a core property valuation system and one or more functional modules. Variously, the modules facilitate automatic adjustment of an equity line of credit, generation and management of an equity credit card, unsecured debt conversion to an equity loan, rapid closing of a conforming loan, automated PMI removal, property rating and/or ranking for buyers and sellers, evaluation and alerts, relocation alerts, relocation forecasting, property tradeoffs, and broker evaluations.

### CROSS REFERENCE TO RELATED APPLICATIONS

This application claims the benefit of priority from the following, commonly owned U.S. Provisional Patent Applications:

Ser. No. 60/222,517, filed Aug. 2, 2000, entitled Property Analysis and Management System and Method;

Ser. No. 60/222,400, filed Aug. 2, 2000, entitled Automatically Adjusting Equity Loan System and Method;

Ser. No. 60/222,391, filed Aug. 2, 2000, entitled Equity Card System and Method;

Ser. No. 60/222,515, filed Aug. 2, 2000, entitled Unsecured Debt Conversion System and Method;

Ser. No. 60/222,401, filed Aug. 2, 2000, entitled Rapid Close Conforming Loan System and Method;

Ser. No. 60/222,399, filed Aug. 2, 2000, entitled Automated PMI Removal System and Method;

Ser. No. 60/222,452, filed Aug. 2, 2000, entitled Property Rating and Ranking System and Method;

Ser. No. 60/222,514, filed Aug. 2, 2000, entitled Property Evaluation and Alert System and Method;

Ser. No. 60/222,453, filed Aug. 2, 2000, entitled Seller-Based Property Rating System and Method;

Ser. No. 60/222,397, filed Aug. 2, 2000, entitled Relocation Alert System and Method;

Ser. No. 60/222,493, filed Aug. 2, 2000, entitled Relocation Forecasting System and Method;

Ser. No. 60/222,516, filed Aug. 2, 2000, entitled Property Tradeoff System and Method;

Ser. No. 60/222,513, filed Aug. 2, 2000, entitled Broker Evaluation System and Method; and

Ser. No. 60/231,928, filed Sep. 11, 2000, entitled Property Guaranteed Valuation System and Method.

### FIELD OF THE INVENTION

The present invention generally relates to automated processing computer systems. More specifically, the present invention relates to computer-based systems and methods for facilitating evaluations and transactions relating to real and other properties.

### BACKGROUND OF THE INVENTION

With the proliferation of the Internet and World Wide Web (“Web”), many individuals and organizations are rushing on-line to provide information and applications to a growing number of Web enabled recipients. Often, an organization, like a business, will adapt its traditional business model to include Web access. For example, many e-commerce sites allow consumers to place orders on-line. As another example, information providers may allow access to information, such as news, via the Web, in addition to traditional print or television mediums. That is, users can accomplish with a computer platform what they typically have accomplished by other means. In commercial models, relationships may be business to consumer (“B2C”), business to business (“B2B”), or consumer to consumer (“C2C”).

In a real estate context, there has been a migration of traditional sales models to the Web. As examples, classified adds, broker adds or multiple service listings are available on the Web through a variety of sites. A real estate advertising site may include links to mortgage companies, banks, credit reporting agencies, home inspectors, home appraisers, or contractors Web sites. Some real estate related sites may also include a mortgage calculation engine that allows the user to get an idea of the amount of loan they could obtain. Such sites may also include links to real estate sales data providers, such as the Banker and Tradesman (at www.bankerandtradesman.com).

Additionally, automated real estate valuation engines may be used to generate real estate appraisals or property valuations, whether via a Web site or other system. Such valuation engines typically generate property valuations based on property characteristics, prior sales of the subject property, location, and recent sales of nearby properties. These are typically systems that provide an automated alternative to the pen and paper methods traditionally used.

Automation of traditional business models and migration to the Web is useful, although in certain contexts limited. In the real estate context, such migration has provided a wider scale of access to consumers and real estate professionals. However, much of this takes the limited form of providing a different medium to present traditional information and services.

Typical Web based real estate systems offer very little in the way of analytical tools that may assist buyers, sellers and brokers, for example, in using and interpreting the significant amount of real estate data becoming available on-line.

### SUMMARY OF THE INVENTION

A system and method in accordance with the present invention includes a core property valuation system and a set of modular functionality that makes use of corresponding property valuations to generate property value related information or perform property value related functions. This modular functionality may be B2B, B2C, or C2C oriented, as examples, depending on the configuration of the system. Such a system may include any combination of the several components or functional modules described below.

Preferably, a system in accordance with the present invention is a network-based system, or at least includes an interface to allow access to the various functionality described herein by network enabled devices. As a network-based system, access need not be open public access, but rather could be selectively restricted to those individuals or organizations having memberships with a corresponding service provider or to those willing to purchase access to such functionality in various other manners, such as on a transaction basis.

A system in accordance with the present invention may be configured for access by any of a number of network enabled devices (or “client devices”). A client device may be any electronic device that is enabled to accomplish or take part in transactions via a network. For example, the client device may be a personal computer (PC), such as a workstation, desktop or laptop system, or a server. The client device may also be any of a variety of other devices, such as a personal digital assistant (PDA), e-mail device, telephone, cellular telephone, or networked enabled television or appliance, as examples. Further, a system in accordance with the present invention may be accessible over any of a variety of networks, such as the Internet, World Wide Web (the “Web”), intranets, extranets, local area networks (LANs), wide area networks (WANs), private networks, virtual private networks (VPNs), and so forth, or any combination thereof.

The core property valuation system includes a processing device (e.g., one or more servers) having access to one or more databases of historical real estate sales and real estate characteristics information. For example, the databases may include a set of property-based information for each of a large volume of property addresses, including such information as the number of bedrooms and bathrooms, square footage, lot size, and/or sales price for a property. The database may also include information such as asking price, time on market, and a record of offers received. As will be appreciated by those skilled in the art, data may also be provided by third party sources, via a network. While the property valuation system is described primarily with respect to real property, the property valuation system could also be configured to accommodate any type of property where sales and characteristics information is available.

An application system may be linked to the property valuation system and include or access various companion functional modules. For the most part, the functional modules, as described below, are configured to generate certain types of information or perform certain tasks using information provided from the property valuation system and other relevant information. The application system may serve as a local, front end system to the property valuation system. Or, the application system and the property valuation system may be independent systems, wherein the application system may be configured to access the property valuation system as needed via any of a number of standard form networks and communication links, as described above.

A supplemental set of data (or a database) may be included that facilitates a correlation between sales data in the property valuation system database and other financial information or economic indicators, such as interest rates, inflation, GNP, CPI, unemployment rate, or any of a number of other such types of data. This supplemental data may be provided with the application system or by a third party system.

An automatically adjusting equity loan (AAEL) system and method in accordance with the present invention provides a means in, for example, a real property context for a line of credit to be established or an existing line of credit to be adjusted with respect to equity in a subject property (e.g., the property owner's home). Generally, property value, and therefore equity, increases over time, although periods of decreases may be experienced from time to time. The AAEL system automatically increases the limit on the equity line of credit accordingly. If equity in the subject property decreases due to, for example, a drop in market values, an existing borrowing limit on a line of credit could be decreased accordingly, if desired.

The AAEL system includes or accesses an account management system and accesses the property valuation system. The account management system may be the system of a lender with which an equity loan is held and managed. The AAEL system accesses the property valuation system and the account management system to determine whether, based on a change in the value of a subject property, the limit on an equity line of credit may be adjusted higher (or lower). The AAEL system is configured to adjust the equity line of credit accordingly. A notification, such as an e-mail, may be sent to the property owner to alert the owner (and gain the owner's consent if desired) to the change. The system could also be configured to obtain approval from the borrower before increasing the limit, which could be accomplished electronically. In addition to the third party data sources mentioned previously, interfaces to other third party systems may also be included, such as those that provide credit reporting services and lending guidelines. The various systems herein may be owned, controlled or operated by one or more entities.

An equity card (EC) system and method in accordance with the present invention provides a means to manage a chargeable equity line of credit for a client. The equity line of credit is backed by a piece of property. The client is issued an equity card useful for typical credit card type transactions and charges against the equity line of credit. Charges against the equity card result in distributions from the equity line of credit, under control of the EC system. The EC system bills the client according to the existing balance of the equity line of credit. The EC system may be used to establish a fixed equity card line of credit, or it may be used in conjunction with the AAEL system previously discussed, which provides an adjustable line of credit. When the AAEL system is included, changes to the limit of the equity line of credit may be “pushed” or “pulled”.

An unsecured debt conversion (UDC) system and method in accordance with the present invention facilitates conversion of unsecured debt, such as typical credit card purchases, for example, to debts secured by a subject property. The amount of debt that may be secured may not be greater than the equity in the subject property. As used herein, the term “conversion” refers to generating a lien against the subject property, typically real property, to secure a given amount of existing unsecured debt. The UDC system may be implemented as part of a financial services institution's account management system, such as the account management system previously discussed. In other forms, the UDC system may be implemented as a standalone system interfaced with providers of mortgage, loan, and/or lien information.

The UDC system obtains the balance of all mortgages and equity loans against a subject property from, for example, an account management system. Additionally, the UDC system obtains a current automated property valuation from the property valuation system. Using this information, the UDC calculates amount of available equity in the subject property, as the difference between valuation and debt against the subject property. The UDC system uses the amount of equity to determine whether the amount of unsecured debt can be converted. Part of this determination may include checking credit reporting information related to the client and applying relevant financial, tax and/or lending guidelines. If the client assents to the debt conversion, the UDC system generates a lien against the subject property and distributes an amount corresponding the amount of previously unsecured debt. The UDC system may be configured to pay unsecured debt by electronic means. Generating a lien includes generating typical documentation that may be recorded with a registry of deeds, for example. The debt conversion opportunity may be pushed or pulled. In the case of pushing, an alert generator may be included that, for example, sends an e-mail alert to the client informing the client of the opportunity.

A rapid close (RC) system and method in accordance with the present invention provides an automated means for generating a loan amount and interest rate in substantially real-time for a conforming loan, with respect to an automated valuation. The RC system may be a standalone system or it may be part of an account management system. The account management system includes an account manager module of a first lender seeking to provide a rapid close first mortgage loan to a client seeking to purchase a subject property. Upon request for a mortgage by a client via the Internet, for example, the RC system determines the client's eligibility for a loan for the subject property. The property valuation system returns an automated valuation for the subject property. With the automated valuation, the RC system determines the client's eligibility for a mortgage, applying the relevant guidelines. If approved, the client is notified, preferably via e-mail alert.

Generally, if the loan to value ratio (LTV) of a mortgage loan is 80% or less, the loan is considered to be conforming, otherwise the loan is considered non-conforming. Traditionally, lenders require that an appraiser visits the subject property before the loan can be closed. Therefore, using traditional models the loan could not be quickly closed, but it can be quickly guaranteed using the RC system. When the traditional appraisal is required for the subject property there will be two property valuations: the automated valuation and the traditional appraisal. The automated valuation is determined substantially in real-time and there may be a traditional appraisal which is conducted some time after the real-time automated appraisal. Using the automated valuation, the client may be guaranteed a conforming loan, with respect to the automated property valuation. The loan amount and interest rate are guaranteed.

Ultimately, if the traditional appraisal is less than the automated valuation, the loan may be considered to be non-conforming with respect to the traditional appraisal. In such case, a first mortgage loan is given for an amount less than the requested amount, yet conforming with respect to the traditional appraisal. This creates a shortfall amount between the requested loan amount and the first mortgage loan. A second loan amount is determined and is issued to cover the shortfall. The second loan is made to maintain the overall guaranteed amount and interest rate.

If the interest rate of the second loan is greater than the guaranteed interest rate, the present value corresponding to that difference may be determined so that the guaranteed interest rate may be maintained for the second loan. That present value is either paid up front as a fee, either by the client or by the first lender, or it may be waived by the second lender. As a result, the first lender can maintain its promise or guarantee of loaning a certain amount of money based on the automated appraisal and having a given interest rate. In another embodiment, if the second loan interest rate is above the guaranteed interest rate, the first lender may decrease the first loan interest rate such that the effective interest rate across both loans is equal to the guaranteed interest rate.

An automated PMI removal system and method in accordance with the present invention provides a means for automatically removing private mortgage insurance from an existing mortgage. The PMI removal system may be part of a mortgage account management system or a standalone system that interfaces with a mortgage account management system. The system also interfaces with the property valuation system. The account management system administers a client's underlying mortgage loan and related PMI account. The PMI removal system obtains a property valuation from the property valuation system and obtains a mortgage balance from the account management system. The PMI removal system determines whether the LTV ratio is 80% or less, for example. In one form, the PMI removal system may automatically remove the PMI from the existing mortgage. In another embodiment, the PMI removal system may generate a new loan opportunity for the client, wherein PMI would not be required given the LTV ratio. In removing the PMI or generating a new mortgage wherein PMI would not required, the PMI removal system applies the necessary guidelines to ensure that federal regulations and other requirements are met. PMI removal opportunities may be pushed or pulled.

A property rating and ranking (R&R) system in accordance with the present invention provides an analysis and ultimately a rating and/or ranking of a list of candidate properties of interest to a client. The candidate list may be a client defined set of candidate properties, an R&R system returned set of properties, or some combination thereof. If the client is interested in one or more specific properties already known to the client, the client may build the client list by entering those addresses. Otherwise, a client buyer enters a set of candidate property criteria. The candidate property criteria may include any of a plurality of different types of criteria commonly used by buyers or sellers (e.g., geographic location, property type, number of bedrooms, number of bathrooms, and so on). In this latter case, the R&R system queries available property listing systems and DBs to obtain a list of candidate properties substantially satisfying the candidate property criteria. If the client entered specific property addresses, the R&R system may query other systems to obtain information (e.g., typical listing information) useful in rating and ranking the candidate list. The R&R system, using listing information from the client entered addresses, may be configured to form a set of candidate property criteria and to perform a query to find additional candidate properties. In such a case, the client's candidate list may be augmented with these additional candidate properties.

Rating a candidate property involves assessing a property against a set of rating criteria and providing some objective rating indicia or designation based on that assessment. Rating criteria may be client defined or they may be predefined. Predefined criteria may be in the form of standard template sets of criteria provided by the R&R system or they may be a set of industry accepted (or institutionalized) rating criteria. Designations of institutionalized ratings may take any of a variety of forms, such as being designated a “Good Deal” or given a gold star, as examples. The R&R system may also be configured to form a set of rating criteria on behalf of the client in response to, at least in part, client entered information. Preferably, but not essentially, at least one rating criterion is related to automated property valuations. As an example, a rating criterion may be based on a comparison of the asking price of a property against a valuation provided by the property valuation system. In such a case, the property valuation system is queried for automated property valuations of the candidate properties. As an example, if the asking price is at or below the automated property valuation, then the candidate property may be designated as a “Good Deal”. Rating criteria may be weighted uniformly or individual criterion may be weighted differently.

In accordance with the R&R system, ranking involves ordering a set of properties according to one or more of defined ranking criteria. Ranking of the candidate list may be accomplished or ranking may be accomplished using properties beyond those provided in the candidate list. For instance, a candidate property may be ranked #1 in % of list price/valuation among candidate properties (e.g., 1 bedroom condos in Lexington, Mass.), but may be ranked #50 in % of list price/valuation among all condos in Lexington, Mass. The candidate list need not be rated to be ranked. However, when the candidate list properties have been rated, candidate property rating may serve as ranking criterion. Like rating criteria, ranking criteria may be client defined criteria or predefined criteria. Ranking criteria may be weighted uniformly or individual criterion may be weighted differently.

A property evaluation and alert (E&A) system and method in accordance with the present invention allows a client to enter a set of candidate property criteria and receive automated alerts when one or more candidate properties substantially satisfying the candidate property criteria is located. The candidate property criteria may include any of a plurality of different types of criteria commonly used by buyers or sellers (e.g., geographic location, property type, number of bedrooms, number of bathrooms, and so on). The E&A system queries available property listing systems and DBs to obtain a list of candidate properties substantially satisfying the candidate property criteria. Such queries may be accomplished periodically or may be event driven. Event driven queries may be queries made in response to a client request or may be automatic queries made in response to a change in one or more economic indicators, as examples. As an example of periodic queries, a client may sign up for a service where queries are made hourly, daily, or weekly. When one or more candidate properties are found, an alert is sent from the E&A system to the client (e.g., such as an e-mail via the Internet). The alert may include information on the candidate properties, links to Web sites where the properties are listed, or may simply inform the user to log into the E&A system to view candidate property information.

The E&A system may be used in conjunction with the R&R system previously described. In such forms, candidate properties may rated and/or ranked prior to alerts. And, alerts may be conditioned on at least one candidate property having a certain minimum rating or ranking. Accordingly, the client may also enter rating and/or ranking criteria, or the rating and/or ranking criteria may be institutionalized rating and/or ranking criteria. The E&A system may be configured to keep a log of alerts sent to the client. The E&A system may also conduct any necessary billing of the client, if there is a fee for such services.

A seller-based property rating and ranking (SPR) system and method in accordance with the present invention provides a client seller with the ability to analyze its property (i.e., a subject property) in terms of current (or historical), substantially objective market data. By doing so, the client seller can determine how its subject property would be rated and/or ranked at different price points or with different features, which may prove useful in determining a list price for the subject property. Rating and ranking of the client seller's subject property is accomplished substantially in the same manner as that discussed with respect to the R&R system. In some embodiments, the SPR system may be formed by augmenting the R&R system with SPR functionality.

Accordingly, the client seller enters a set of subject property information, corresponding to typical listing information for its subject property. Preferably, the client seller enters a proposed list price for the subject property. All of the subject property information is editable. Rating and/or ranking may be accomplished, at least in part, by obtaining an automated property valuation of the subject property and comparing the proposed list price to the automated property valuation. Changing the list price for the subject property typically changes the rating and/or ranking, when a criterion is related to price. Rating criteria may be predefined or they may be client defined. If the predefined criteria are institutionalized criteria, the subject property is rated and given an appropriate institutionalized designation. For example, the subject property could be rated a “Good Deal” or given a Gold Star if a certain % of list price/valuation is achieved.

Similarly, using the SPR system the subject property may be ranked among similar competing properties. Ranking criteria may be predefined or client defined. To rank the subject property, a set of similar properties may be obtained from sources having typical listing information. To accomplish this, the SPR system may derive a set of subject property criteria corresponding to typical listing information. Alternatively, the client may define the subject property criteria. A set of competing properties may be obtained from relevant sources and automated valuations may be obtained for each competing property. For example, the subject property could be ranked #1 in % of list price/valuation for all single family homes, 3 bedroom homes in Lexington, Mass.

A relocation alert (RA) system and method in accordance with the present invention provides a client with the capability to evaluate or to have evaluated buying opportunities in a second market or market segment (collectively, “second market”) relative to a first market or market segment (collectively, “first market”). That is, the second market may be the relocation destination and the first market may be the location of the client's current property. The first market may also be compared with additional markets, or a group of potential markets may be composed or evaluated without regard to the first market. The client seeks to be alerted to an optimal time to transition to a next market.

Markets may be defined in a variety of manners. For example, a market may be defined according to a certain geographic location (e.g., a state, city, town, zip code, coordinates, streets, proximity to a point of interest), a certain tier or price range in a given geographic location, a certain type of property regardless of the price, a property having a certain ranking and/or rating, or some combination of these or other parameters. For example, a client may compare condominiums in a metropolitan area with single family homes in a suburb of that metropolitan area. In other examples, a client may compare condominiums in two different urban areas (e.g., Austin, Tex. and Boston, Mass.).

Using the RA system, the client enters information regarding the two markets. A first subset of this information includes information regarding the client's present (or subject) property and a second subset of this information includes candidate property criteria for the second market. A third subset of this information may include evaluation criteria, such as minimum property valuation differential. Otherwise, the evaluation criteria may be predefined, as part of the RA system. The RA system is configured to track the second (or other) market with respect to the first (or other) market over time. As an example, at least in part, this may be accomplished by comparing historical sales data for each market. For the most part, the RA system determines when the differential between the property value of the subject property and the valuation of a candidate property fitting the candidate property criteria is minimal or falls below a certain threshold. When evaluation is being accomplished between markets that do not include the subject property, candidate properties or representative properties from each market are compared. Upon such a determination, the RA system generates an alert (e.g., via e-mail, telephone, or traditional paper mail services) informing the client that it is advantageous to seek a property in the second market. Additionally, the RA system may obtain a candidate list of properties in the second market for the client, which may be rated and/or ranked (e.g., using the R&R system), and/or may provide an automated valuation of the client's subject property in the first market. A client account manager may be included to maintain information related to the client and the first and other markets of interest.

A relocation forecasting (RF) system and method in accordance with the present invention allows a client to have forecasted an optimal time to relocate from a first market to a second market. The RF system may also be used to compare a second market and third market, where the client does not currently reside in either. The RF system is substantially similar to the RA system, but includes forecasting functionality to analyze trends in each market and, based thereon, to predict a future point in time that it would be advantageous for the client to transition from the first market to a second market. The RF system may also be used to compare a second market and third market, where the client does not currently reside in either.

A property tradeoff (PT) system and method in accordance with the present invention aids a client, typically a seller, in determining a list price for a subject property. The PT system assists the client by, for example, accumulating, processing, and presenting market data that allows a client to make tradeoffs between a list price for the subject property (relative to automated valuation) versus time on market (TOM). Therefore, given an automated valuation for the subject property, the client can predict TOM at different list prices.

Using the PT system, the client enters information describing the subject property, including traditional listing information, such as location (e.g., address), property type (e.g., single family home), and so on. From this information, the PT system derives or defines criteria for searching sales of comparable properties (i.e., “comparable property criteria”). Otherwise, the client may define, at least to some degree, the comparable property criteria. The PT system searches relevant systems and DBs for properties sold within a certain period of time (e.g., the last 6 months) and obtains a list of comparable properties substantially satisfying the comparable property criteria. The list of comparable properties includes property addresses and each property's list price, sale price, list date and date of sale. For each comparable property, a TOM is determined using the list and sale dates.

Once a list of comparable properties is obtained, the PT system queries the property valuation system, which returns a current automated property valuation for each comparable property. For each comparable property, the automated property valuation may be regressed to the listing date; regression may be accomplished in any of a variety of known manners (using known math modeling techniques). Given the regressed automated property valuation, list price, sale price, and TOM for each comparable property, the PT system constructs a model that the PT system applies to the subject property to predict the TOM at different list prices. The PT system can also include functionality to predict the sale price as a function of list price and automated property valuation. For example, the model may indicate that when the list price is 90% of the automated valuation, the TOM is predicted to be 15 days and the sale price is predicted to be 102% of the automated property valuation (or 110% of asking price). Of course, other manners of representing this or similar information may be used. Also, any of a wide variety of predictive models known in the mathematical arts may be used.

A broker evaluation (BE) system and method in accordance with the present invention may be used by a client to identify in real-time one or more candidate brokers and/or agents (collectively “brokers”) to be used to sell or buy a subject property. For example, a client buyer may use the BE system to find a buyer's broker and a client seller may use the BE system to find a seller's broker. Preferably, the BE system facilitates the client's selection of a broker based on past performance of that broker, and possibly based on past performance relative to other brokers in the relevant market. For example, a broker's performance may be based on various performance criteria, such as sales price or TOM relative to valuation. When there are a plurality of performance criteria, the performance criteria may be weighted.

Using the BE system, the client may enter a list of candidate brokers or may obtain a candidate list from the BE system. Using the list of candidate brokers, the BE system searches relevant systems and databases and retrieves historical sales data relevant to those candidate brokers. The sales data preferably includes identification of each sold property, the broker, the list price and date, and sale price and date. As described with the PT system, for each property a current automated property valuation is determined and regressed to the list date, yielding a retrospective property valuation. The BE system then analyzes each broker's performance using the retrospective property valuations. For example, a broker that had an average sale price of 98% of property valuation may be evaluated as being superior to a broker that had an average sale price of 95 % of property valuation. Brokers may also be evaluated with respect to TOM.

The BE system may also include functionality to rate and/or rank each broker with respect to property valuation, for example. That is, the performance criteria may include rating and/or ranking criteria. For example, a broker that has an average sale price of >98% of automated valuation may achieve an “A” rating. Ratings can be based on predefined rating criteria or on client defined rating criteria. When predefined, the rating criteria may be institutionalized ratings based on industry accepted rating criteria or may be other system defined rating criteria. Additionally, or alternatively, brokers may be ranked, using either predefined or client defined ranking criteria. When predefined, the ranking criteria may be institutionalized rankings based on industry accepted ranking criteria or may be other system defined ranking criteria. Rating may serve as a ranking criteria. Brokers may be rated and/or ranked with respect to a certain geographic area, price range, TOM, % of sale price to property valuation, within a market for a certain property type, and so on. For example, a broker may be rated or ranked highly with respect to sales of single family homes, but may not be rated and/or ranked as well with respect to sales of condominiums.

A property guaranteed valuation (PGV) system and method in accordance with the present invention provides for the wrapping of a guarantee or insurance policy around a forecasted default valuation (DV) for a subject property. The DV is a low end valuation of the subject property, for example the sale price of the subject property at foreclosure or auction. At the time of mortgage loan application, for example, an automated property valuation is obtained and a DV is obtained. Forecasted valuations and DVs are also determined for one or more points in time. The forecasted DVs are useful, for example, to potential lenders or mortgage companies and are also useful to client buyers and sellers for determining a worst case sale price of a subject property, any of which may be beneficiaries of the guarantee.

Forecasted valuations may be formed as described with respect to the RF system above. Forecasted DVs may be accomplished in the same manner. Alternatively, forecasted DVs may be formed by determining a default correction factor, which may be used to discount the forecasted valuation at each selected point in time to arrive at a forecasted DV at that same selected point in time. The default correction factor is preferably market and/or economy based, derived from historical data, and may be a constant or may vary as a function of forecasted changes in the market and/or economic parameters that effect the default correction factor. An insurer, or other guarantor, issues a guarantee (e.g., an insurance policy) of DV for a selected period of time, based on the forecasted property valuations and forecasted DVs. The guarantee may be given as a minimum DV for the guarantee period, or may be made against a schedule of forecasted DVs at different points of time throughout the guarantee period, such that the guaranteed DV at month 6 may be different than the guaranteed DV at month 12. If the subject property is sold at foreclosure for less than the guaranteed DV, the guarantor pays the beneficiary the difference.

As will be appreciated by those skilled in the art, the various systems described above may be combined in any manner to form a more comprehensive system.

### BRIEF DESCRIPTION OF THE DRAWINGS

The foregoing and other objects of this invention, the various features thereof, as well as the invention itself, may be more fully understood from the following description, when read together with the accompanying drawings, described:

FIGS. 1A, 1B, and 1C are computer architectures that may host the various functional modules of the present invention;

FIG. 2A is a block diagram of an AAEL module in accordance with the present invention;

FIG. 2B is a flow chart depicting a method implemented by the AAEL module of FIG. 2A;

FIG. 3 is a block diagram of an EC module in accordance with the present invention;

FIG. 4 is a block diagram of a UDC module in accordance with the present invention;

FIG. 5 is a block diagram of an RC module in accordance with the present invention;

FIG. 6 is a block diagram of a PMI module in accordance with the present invention;

FIG. 7A is a block diagram of an R&R module in accordance with the present invention;

FIG. 7B is a flow chart depicting a method implemented by the R&R module of FIG. 7A;

FIG. 8 is a block diagram of an E&A module in accordance with the present invention;

FIG. 9A is a block diagram of an RA module in accordance with the present invention;

FIG. 9B and FIG. 9C are block diagrams showing various market relationships with are supported by the RA system of FIG. 9A.

FIG. 10 is a block diagram of an RF module in accordance with the present invention;

FIG. 11 is a block diagram of a PT module in accordance with the present invention;

FIG. 12 is a block diagram of a BE module in accordance with the present invention;

FIG. 13 is a block diagram of a PGV module in accordance with the present invention; and

FIG. 14 is a block diagram of a system incorporating all of the functional modules of FIGS. 2A through 13 and implemented on the architecture of FIG. 1A.

For the most part, and as will be apparent when referring to the figures, when an item is used unchanged in more than one figure, it is identified by the same alphanumeric reference indicator in all figures.

### DETAILED DESCRIPTION OF THE PREFERRED EMBODIMENT

A system and method in accordance with the present invention includes a core property valuation system and a set of modular functionality that makes use of corresponding property valuations to generate property value related information or perform property value related functions. This modular functionality may be B2B, B2C, or C2C oriented, as examples, depending on the configuration of the system. Such a system may include any combination of the several components or functional modules described below.

Preferably, a system in accordance with the present invention is a network-based system, or at least includes an interface to allow access to the various functionality described herein by network enabled devices. As a network-based system, access need not be open public access, but rather could be selectively restricted to those individuals or organizations having memberships to a corresponding service provider or to those willing to purchase access to such functionality in various other manners, such as on a transaction basis.

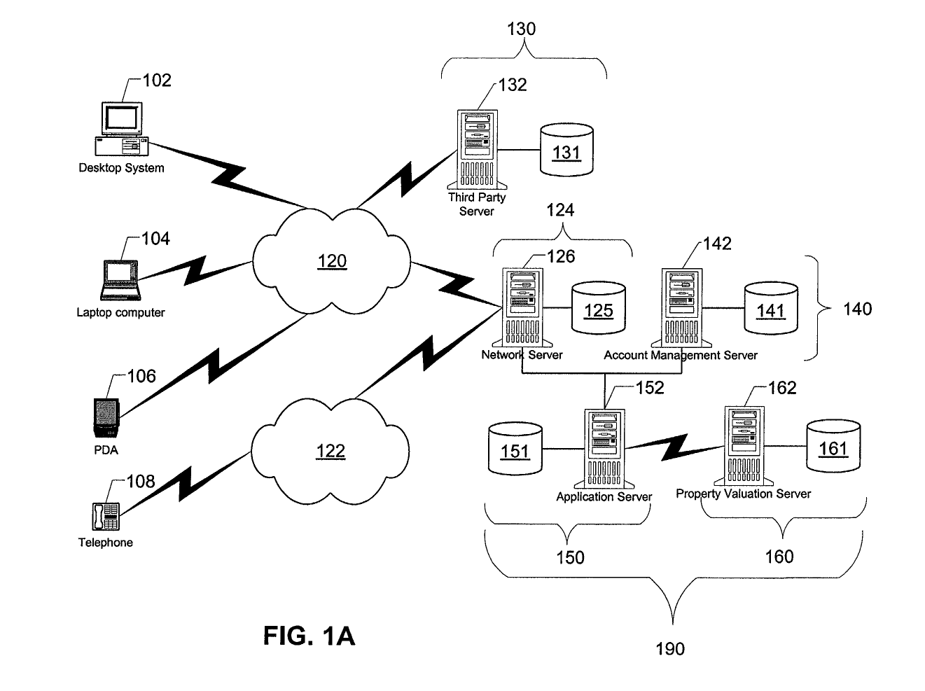

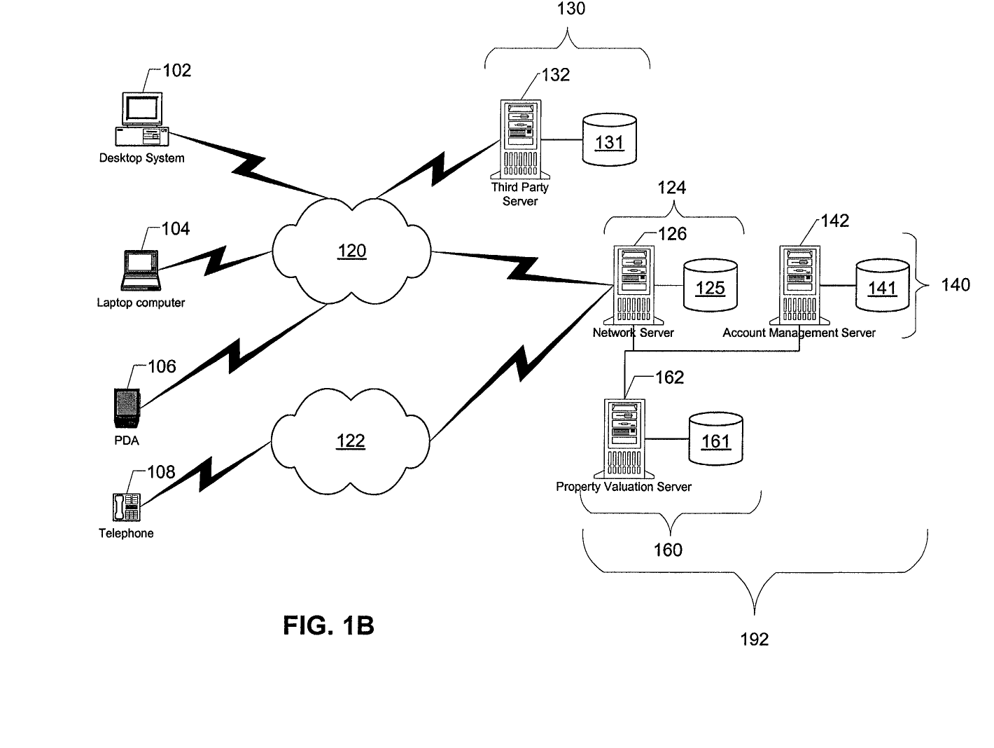

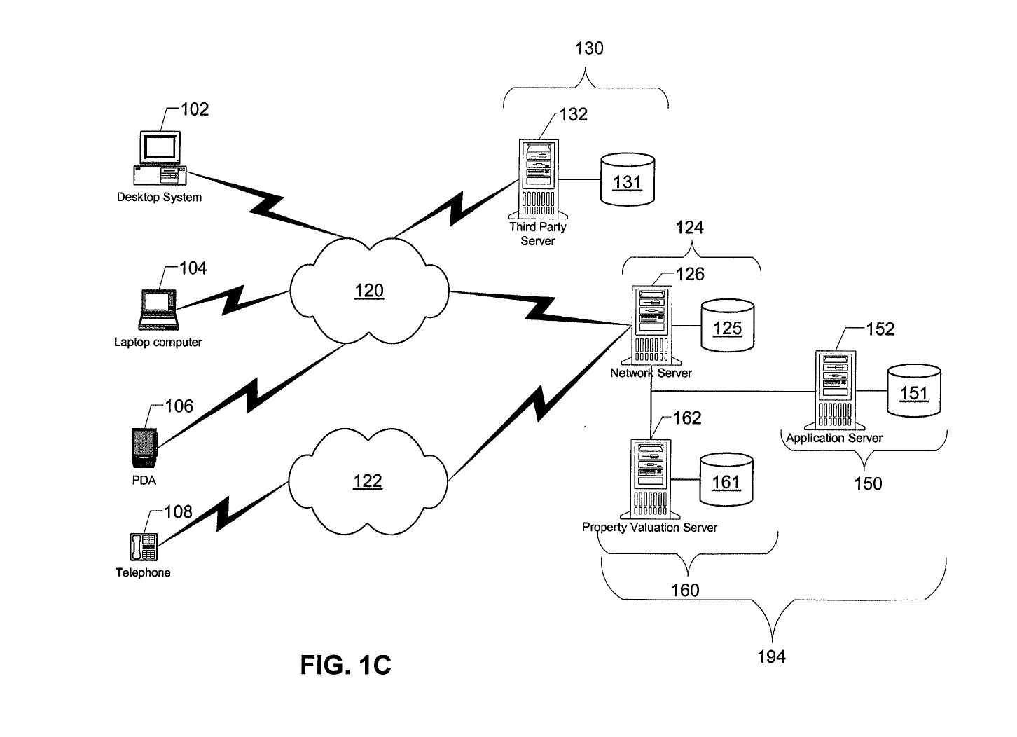

Generally, a core system is provided that includes a network interface system 124 and a property valuation system 160, as is shown in FIG. 1A, FIG. 1B, and FIG. 1C. The network interface system 124 includes one or more servers 126 and databases (DBs) 125 including known network functionality and data for facilitating interaction with an application system 150 by clients via a network. For illustrative purposes, the application system 150 includes an application server 152 and associated DB 151. Methods and systems for performing property valuations (or appraisals) are generally known in the art and not discussed in further detail herein. In the preferred form, the property valuation system 160 is the CASA™ system by Case Shiller Weiss, Inc. of Cambridge, Mass., which is configured to provide automated property valuations over the Web (see www.cswcasa.com). Property valuation system 160 is represented by a server 162 and associated DB 161. Application system 150 is configured to host the various functional modules described below. As will be appreciated by those skilled in the art, various functionality is depicted herein as being related to and executed on standalone systems, but in practice these systems may be combined, shared, or distributed over many subsystems. That is, the present invention is not inherently limited to any of the architectures described herein.

In the preferred form, the property valuation system 160 includes a property valuation program or application executed by the property valuation server 162 to determine and return a property valuation of a subject property in response to a request. When the subject property is real property, the request includes a street address of the subject property and, potentially, other relevant information (e.g., number of bedrooms in a house). The property valuation database 161 may be used to store the property valuation application instructions (including algorithms and modeling techniques) and parameters, factors and/or other data used in the valuation of the subject property, as well as historical real estate transaction data. The factors may, for example, include weighting factors related to the square footage of living space, number of bedrooms, condition, lot size, town, and so on. The data may include recent sale prices for the street, neighborhood, or town of the subject property. These parameters and factors may alternatively, or additionally, be supplied by a third party interfaced to the property valuation system 160, for example, through third party (TP) system 130.

Generally, a third party system 130 may be a source of information or services relevant to the different functional modules described below. Third party system 130 is depicted as including a third party server 132 and a third party DB 131, as a generic embodiment. An account management system 140 may also be provided, which is generically depicted as having a server 142 and DB 141. Account management system 140 may be a system used by a lender to manage mortgages or equity loans or it may be a system used to manage client accounts related to the provision of other property related services.

As shown in each of FIG. 1A, FIG. 1B and FIG. 1C, systems in accordance with the present invention may be accessed by any of a plurality of types of wired or wireless devices over any of a variety of networks. Those skilled in the art will appreciate that the present invention can be embodied in other types of configurations, including a variety of types of networks. For example, a system in accordance with the present invention may be accessible over networks such as the Internet, World Wide Web (the “Web”), intranets, extranets, local area networks (LANs), wide area networks (WANs), private networks, virtual private networks (VPNs), telephone networks, or any combination thereof. For example, a computer (e.g., desktop system 102) or a personal digital assistant (PDA) 106 or other Web-enabled devices may access such systems via the Internet and Web 120. In such a case, network server 126 is a Web server that hosts a Web site accessed by clients (e.g., current or potential property owners) and includes means to facilitate e-mail exchanges between clients and the various systems depicted in FIG. 1A, FIG. 1B and FIG. 1C. Additionally, a system in accordance with the present invention may be accessed via a cellular or standard telephone devices (e.g., phone 108) over a telephone communications network 122. The various servers and databases shown may be integrated into fewer servers and databases or a greater number of servers and databases may be included.

A system and/or method in accordance with the present invention may include any or all of the several components and/or functionality described in the various parts herein. In the most comprehensive embodiment, all components or functional modules are integrated into a single system capable of performing the corresponding methods. In any of the various embodiments, preferably a Web-based interface is provided to allow access to the various functionality described herein by any Web and/or Internet enabled device. Although, other interfaces may be supported as well.

Part 1. Automatically Adjusting Equity Loan System and Method

An automatically adjusting equity loan (AAEL) system in accordance with the present invention provides a mechanism in, for example, a real property context, for a line of credit to be established or an existing equity loan to be adjusted with respect to equity in a subject property. Generally, an owner's equity in real property increases over time, since property values generally increase over time. While increases in equity for real property are the norm, periods of decreases are experienced from time to time. Potentially, if equity in the subject property decreases due to, for example, a drop in market values, a borrowing limit on an existing line of credit or on a new equity based borrowing opportunity could be decreased accordingly. Although this is considered to be an atypical scenario, the AAEL system may be configured to accommodate it.

An AAEL system in accordance with the present invention may be implemented on any of the architectures of FIG. 1A, FIG. 1B, or FIG. 1C. In the illustrative embodiment, the AAEL system is implemented on architecture 190 of FIG. 1A. Architecture 190 includes account management system 140, property valuation system 160, and network interface system 124, which facilitates communication between the AAEL system and its clients. Additionally, the AAEL system may include interfaces to third party systems and data (e.g., third party system 130 depicted by server 132 and database (DB) 131). Such third party systems may provide, for example, credit reporting or rating information, lending guidelines, economic indicators or status, as may be necessary or useful in preparing, assessing, approving and/or processing a loan. The various systems may be owned and operated by the same entity or different entities, and they may be co-located, remote to each other, or some combination thereof.

For the AAEL system, the account management system 140 is that of a financial services institution, such as a lender or broker (collectively referred to as the “lender”). Account management system 140 is configured to maintain and administer equity loans offered and obtained (or adjusted) using the AAEL system. If an underlying loan (e.g., a first mortgage or equity loan) exists against the subject property, it may be administered by account management system 140. Otherwise, the underlying loan may be administered by a different lender and on a different system (not shown).

An adjusted equity loan may take one of several forms, all of which are preferably supported by the AAEL system. In a first form, the adjusted equity loan is an increase in the limit of an existing loan against the subject property (e.g., an existing first mortgage loan). In a second form, the adjusted equity loan may be manifest as an increase in the limit of an existing, second loan against the subject property (e.g., a second mortgage or equity loan). In a third form, the adjusted equity loan may be a newly created loan (e.g., a first mortgage or subsequent equity loan) against the subject property. In some instances, more than one of these types of loans may be concurrently accommodated by the AAEL system.

The adjusted equity loan may be offered by a lender that is different from the lender of the underlying loan (or the “first lender”), if there is an underlying loan. In such a case, the information regarding the underlying loan (e.g., loan balance) may be provided to the AAEL system via a link to a third party system. Also, where an underlying loan does exist with a first lender, the AAEL system may be used by a second lender to offer a refinancing opportunity to the owner of the subject property, at an amount sufficient to pay off all existing obligations against the subject property plus any additional funds up to the limit of the adjusted equity loan. In such a case, the AAEL system facilitates the closing of the new loan, the establishment of the new loan in the account management system 140 and paying off the underlying loan(s) with the first lender (and any other lenders).

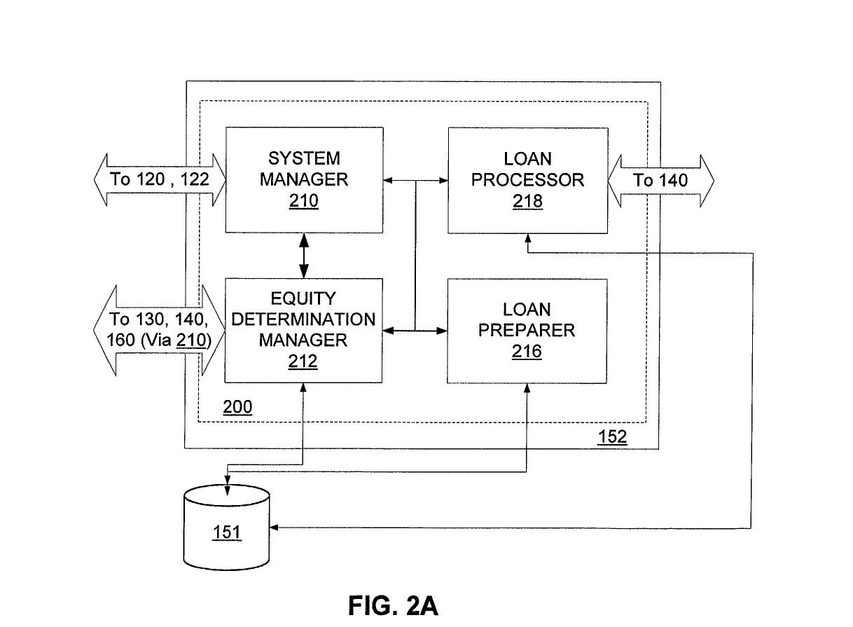

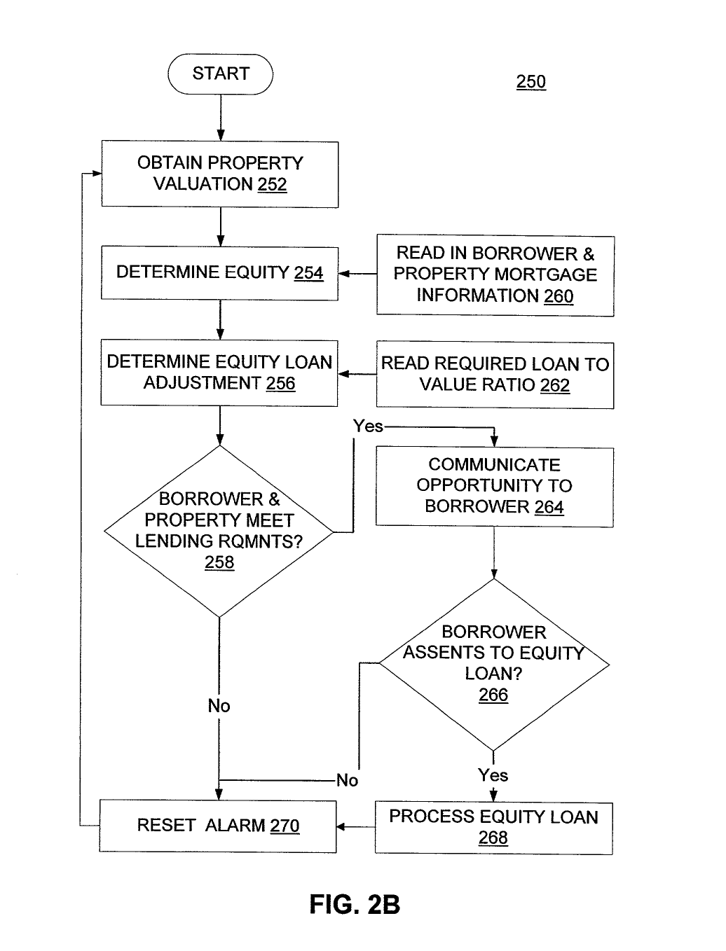

In the illustrative embodiment of FIG. 1A, hosted on the application system 150 is an AAEL application 200 (see FIG. 2A). In other embodiments, such as those of FIG. 1B and FIG. 1C, the AAEL application 200 may be hosted on either of servers 132 or 142. A corresponding method of administering an adjustable equity line of credit is also depicted in flow chart 250 at FIG. 2B. The AAEL application 200 includes a system manager 210 that manages interfaces, directs the basic tasking, and otherwise performs the general administration of application 200. Also included are an equity determination manager 212, a loan processor 216, and a loan preparer 218. The evaluation of a client and a subject property for an adjusted equity loan is performed as a function of receipt by system manager 210 of a request that includes an identification of the client and the address of the subject property, as discussed in further detail below. If the client has an underlying loan(s) (e.g., mortgage and/or equity loan) against the subject property with the lender, the equity determination manager 212 tasks account management system 140 to return information regarding the client and the underlying loan(s). Additionally, or alternatively, if there are outstanding loans against the subject property with a different lender, the system manager 210 obtains the necessary principle amounts, as a minimum, from a third party source.

The AAEL system's equity determination manager 212 tasks the property valuation system 160 to return a current automated property valuation for the subject property, step 252. Based on the automated valuation and the outstanding debt against the subject property, which is read in step 260, the equity determination manager 212 determines the amount of equity in the subject property, step 254. The amount of equity is stored in DB 151, for use by the equity loan preparer 216. Applying any required loan to value (LTV) ratios, step 262, a maximum amount of available equity loan is determined, step 256. The loan preparer 216 applies guidelines (e.g., Fannie Mea and Freddie Mac), credit information, interest rate information and so on, in step 258, to determine if the client qualifies for an equity loan amount at the adjusted limit (i.e., adjusted equity loan). If the adjusted equity loan can be generated, the loan preparer 216 approves the client for the adjusted equity loan. Corresponding adjusted equity loan information is stored in DB 151, e.g., identification of the client and subject property, the adjusted equity loan amount and its terms.

The adjusted equity loan opportunity may be communicated, step 264, to the client for authorization or may be automatically closed, based on prior authorization by the client to close the adjusted equity loan when the client is approved for such a loan. Otherwise, the client may be presented with the opportunity and assent to the adjusted equity loan after receiving a notification, step 266. To close the adjusted equity loan, loan processor 218 accesses the loan information from DB 151 and completes processing of the equity loan, step 268. Closing the loan includes establishing or updating an equity loan account with account management system 140 and proffering and/or distributing the corresponding equity loan proceeds. Once closed, the account management system 140 accomplishes subsequent billing and administration of the equity loan. As indicated previously, if equity in the subject property has decreased, the limit on the line of credit may be decreased, although lenders may choose not to decrease equity line of credit limits.

The process for evaluating and approving a client for an adjusted equity loan may be triggered in any of a variety of manners and an approved adjusted equity loan may be “pushed” to or “pulled” by the client (i.e., property owner). An opportunity to adjust the limit of an equity loan is pushed to a client when the lender triggers the process and communicates the opportunity to the client. The lender may trigger the process periodically (e.g., monthly) or according some other predetermined schedule. In such cases, an alarm may be set to trigger the process and reset after each time the process completes, step 270 (see FIG. 2B). In other cases, the lender may trigger the process based on a variety of other factors (e.g., a drop in interest rates), which may also include alarms. In either case, the lender may trigger the process automatically, wherein triggering criteria and logic are included in the system manager 210 or the equity determination manager 212.

An opportunity to adjust a limit on an equity loan is pulled when the client solicits a borrowing opportunity from a lender. For example, the client may enter a lender Web site, input the address for a subject property and solicit approval of an equity loan. As part of triggering the evaluation of an equity loan opportunity, the client may initially give consent to have the adjusted equity loan automatically closed, if the client qualifies for an adjusted equity loan. The AAEL system may be configured to automatically close the adjusted equity loan, with a priori consent given by the client predicated on, for example, a variety of criteria or parameters being satisfied. For example, the client may only be willing to have the equity loan automatically closed if the principle equity loan amount is at least $20,000 and the annual interest rate is not greater than 9%. When prior consent is given, the AAEL system notifies the client when an adjusted equity loan is closed.

In somewhat of a hybrid approach, a lender may offer a service for evaluating a client's opportunity for an adjusted equity loan and approving an adjusted equity loan, if possible. In this case, a client may register for the service and receive a notification (e.g., e-mail message or alert) when he is approved for an adjusted equity loan. Additionally, as described above, the client may assent to the automatic closing of the adjusted equity loan, with the potential of having criteria established up front that must be met to close the loan and automatic notifications when the adjusted equity loan is closed.

Regardless of the manner in which the generation of an adjusted equity loan was triggered, approved, assented to and closed, the adjusted equity loan proceeds may be distributed in one or more of a variety of ways. For example, the proceeds may be provided to the client as a check. Depending on the implementation, negotiation of the check may serve as the client's assent to the adjusted equity loan and its terms. Additionally, or alternatively, the AAEL system may be configured to electronically direct the proceeds to one or more other accounts (e.g., a credit card, savings, checking, or investment account). Again, depending on the implementation, the adjusted equity loan opportunity may be communicated to the client electronically (e.g., via electronic mail) and the communication may include mechanisms for the client to have the equity adjusted loan proceeds electronically transferred to one or more accounts, wherein manipulation of the mechanisms (e.g., initiation of a funds transfer) may serve as the client's assent to the adjusted equity loan and its terms.

Part 2. Equity Card System and Method

An equity card (EC) system and method in accordance with the present invention may be appreciated with respect to FIGS. 1A, 1B, 1C, 2A, 2B and 3. The EC system and method provide and manage a chargeable equity line of credit for a client, wherein the client is issued an equity card useful for typical credit/debit card type transactions. “Charges” made with the equity card result in distributions from the equity line of credit. The client is billed when there is an existing balance against the equity line of credit. The EC system may be used with a fixed equity card line of credit or with an adjustable equity line of credit in cooperation with the AAEL system of Part 1. In the later case, the EC system may be integrated into the AAEL system as an optional feature thereof.

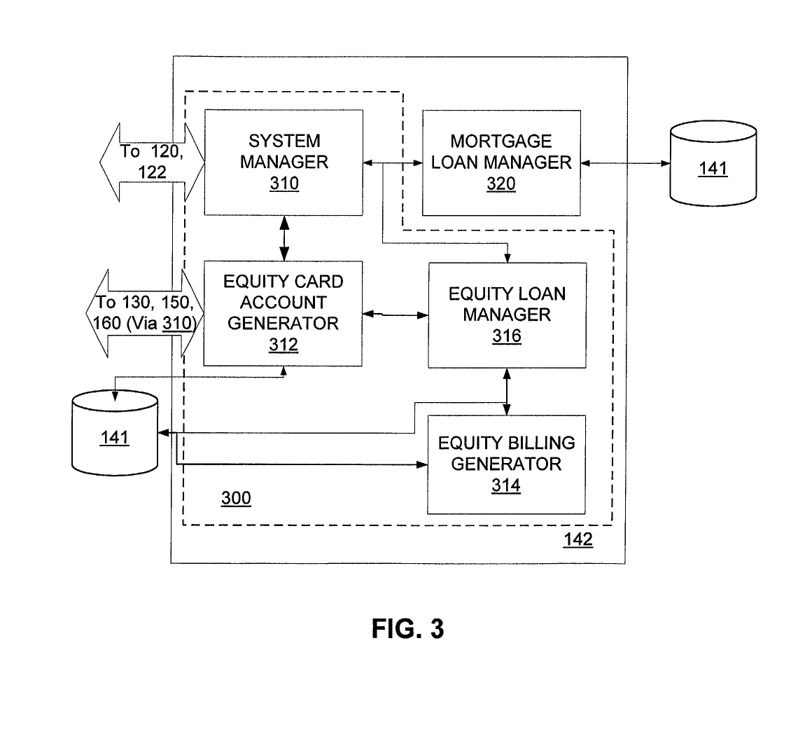

In the illustrative embodiment, the EC system is implemented on the architecture 192 of FIG. 1B, wherein an EC application program is hosted and executed on a typical server. FIG. 3 shows a representative configuration for an EC application 300, which may be hosted and executed on the account management server 142 of FIG. 1B, wherein equity determination system 150 and property valuation system 160 are optional. If the EC system is used in conjunction with the AAEL system, property valuation system 160 is included in the system architecture. As shown in FIG. 3, the account management server 142 includes a typical mortgage loan account manager module (or application) 320 that administers the underlying mortgage(s) stored in DB 141 (and potentially other equity loans that are not associated with the equity card). EC application 300 may also be hosted on a server other than server 142 (e.g., server 132 or 152), but in any case preferably includes an equity card account generator 312, equity card billing generator 314 and an equity loan manager 316.

Once an equity loan (or line of credit) has been closed, such as by AAEL system or by some other means, the equity card account may be generated and the equity card may be issued to the client. If an equity loan has been closed using the AAEL system (e.g., as described with respect to FIG. 2A and FIG. 2B), the equity card account generator 312 accepts equity loan information from the loan processor 218 of the AAEL application 200 (FIG. 2A) and establishes an equity card account for the client in DB 141. The equity loan information includes information such as the equity loan amount, interest rate and other relevant terms. When the AAEL system is not used, the same type of equity loan information is provided to equity card account generator 312 and the equity card account is established for the client in DB 141. Subsequently, the equity loan manager 316 tracks charges to the line of credit (e.g., received via third party systems 130 ) and tasks the billing generator 314 to produce equity loan account statements indicating, for example, the charges made during the last billing cycle, along with the remaining borrowing capacity on the account.

When integrated with, or interfaced to, the AAEL system, the equity card account generator 312 may also be configured to subsequently task the equity determination system 150 to determine whether the equity card line of credit can be increased. The equity card account generator 312 may provide such tasking periodically or under an event-based approach (e.g., at certain time intervals or in response to certain economic indicators, such as a decrease in interest rates or a rise in property values for the relevant region). The event-based approach may occur as a function of event related information received by system manager 310, as provided, for example, by third party systems via network 120, and then passed to equity card account generator 312. Such increases in the equity loan limit may be pushed to or pulled by the client and triggered, as previously described in Part 1.

Part 3. Unsecured Debt Conversion System and Method

An unsecured debt conversion (UDC) system and method in accordance with the present invention may be appreciated with respect to FIGS. 1A, 1B, 1C, 2A, 2B and 4. The UDC system facilitates conversion of unsecured debt, such as is common with typical credit card purchases, for example, to debt secured by a subject property, wherein the amount of equity in the subject property is equal to or greater than the amount of the unsecured debt. As used herein, the term “conversion” refers to generating a lien against the subject property, typically real property, to secure a given amount of existing unsecured debt. In a real property context, generally, securing the debt with a subject piece of real property, by generating a lien against the subject property, offers tax savings opportunities to a client (i.e., owner of the subject property). For example, interest paid on debt secured against a home is typically tax deductible, while interest paid on credit card debt is not typically tax deductible. The UDC system may be implemented as part of a financial services institution's account management system, such as account management system 140 of FIG. 1A, or it may be implemented as a standalone UDC system interfaced (locally or remotely) to sources of mortgage, loan, and/or lien information, other information systems, or borrowers themselves. Beyond a real property scenario, there may be other scenarios for which such debt conversion is advantageous.

The UDC system includes at least one server (or other computing device) having a debt conversion program hosted thereon and access to requisite financial information. As will be appreciated by those skilled in the art,the UDC system may access and serve a plurality of financial institutions and/or clients. The UDC system may be integrated into an account management system 140 of a financial services institution, such as in FIGS. 1A or 1B, or in an application system 150 in the architectures of FIGS. 1A and 1C. Preferably, debt conversion using the UDC system may be pushed (e.g., initiated by a financial services institution and offered to a client) or pulled (e.g., client initiated via a Web site interface) and triggered, in a manner similar to that described with respect to the AAEL system of Part 1.

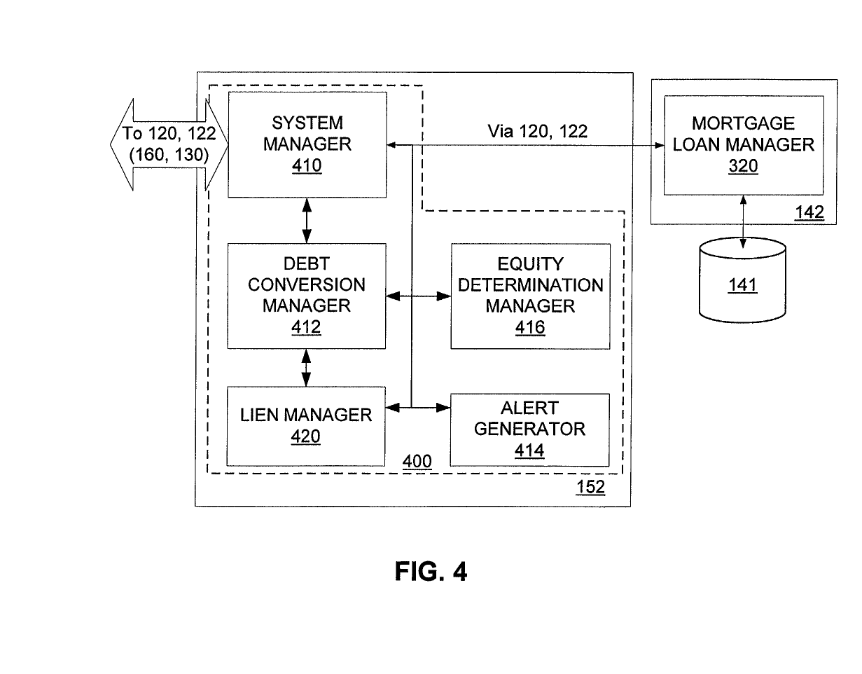

In an illustrative embodiment, the UDC system is implemented on the architecture 190 of FIG. 1A. A UDC application 400 (see FIG. 4) contains the primary functionality of the UDC system and is hosted on application system 150 application server 152 in the illustrative embodiment. Depending on the embodiment, the AAEL system equity loan application 200 of FIG. 2A may or may not be included with the UDC system. Additionally, the property valuation system 160 may also be optional, for example, if the UDC already has access to a useful property valuation for the subject property. However, preferably, property valuation system 160, or some other source, is included to provide real-time current property valuations.

Referring again to the illustrative embodiment of FIG. 1A and FIG. 4 (with UDC application 400 hosted in server 152), preferably server 126 of network interface system 124 is a Web server that hosts a Web site accessible by clients via the Internet and the Web (or network interface system 124 may be part of some other network, such as a LAN, WAN, virtual network, or private network accessible by clients). Preferably, the Web site offers clients a real-time capability to secure previously unsecured debt using the UDC system.

In a Web-based scenario, Web server 126 generates Web pages as a function of client interaction with the Web site and the functionality accessible by the Web server. In the UDC system such functionality includes UDC application 400. In response to a client's interaction with the Web site, the Web server passes requests and data to UDC application 400 and returns data to the client via the Web site. Web server 126 may also exchange information and requests with other applications or systems, such as the AAEL functionality described in Part 1 or third party providers or intended recipients of information or services.

As described in Part 1, the financial account server 142 includes a typical mortgage account manager module (or application) 320 that administers underlying mortgage(s) and/or equity loans stored in DB 141. The UDC application 400 includes functionality that determines whether there exists sufficient equity in the subject property to generate a lien against the subject property and to what extent a lien may be generated (i.e., for what amount of the unsecured debt).

The UDC application 400 includes a system manager 410 that manages interfaces, directs the basic tasking, and otherwise administers the UDC application. For example, upon receipt of a debt conversion request (e.g., from a client via the Web 120), system manager 410 tasks a debt conversion manager 412 to determine whether the client is eligible for debt conversion. Eligibility is primarily a function of the amount of equity in the subject property and the amount of unsecured debt to be converted, assuming the client and equity loan otherwise satisfy relevant lending requirements.

The debt conversion manager 412 tasks various entities (e.g., processes, systems, information providers, etc.) to provide a dollar amount of equity in the subject property. The equity amount determination may be made in a variety of manners, but is fundamentally calculated as a valuation of the subject property minus the amount of debt and/or liens against the subject property. If applicable, any required loan to value ratios are preserved. In a simple form, debt conversion manager 412 tasks an equity determination manager 416 to determine the amount of equity in the subject property. Equity determination manager 416 obtains the balance of all mortgages and equity loans against the subject property from, for example, account management system 140 and obtains a property valuation from property valuation system 160 and calculates the difference. To do this, the address of the subject property is required and the mortgage account manager 320 may be tasked to return the amounts of any outstanding mortgages, equity loans, and liens. Such amounts may also be obtained from typical third party credit reporting agencies.

Once the equity determination manager 416 has determined the amount of equity in the subject property, it passes the equity amount value to the debt conversion manager 412. With the amount of equity in the subject property and the amount of unsecured debt known (e.g., from the client's initial request or application), the debt conversion manager 412 evaluates the client's opportunity to convert the unsecured debt, or at least a portion thereof. Part of this determination may include checking credit reporting information related to the client and applying relevant financial, tax, and/or lending guidelines.

For example, if after considering all loans and liens, there is $20K of equity in subject property and the client has $25K on unsecured debt, the UDC system informs the client that $20K of the $25K may be converted, i.e., secured by the subject property. If the client assents to the debt conversion, debt conversion manager 412 tasks a lien manager 420 to pay the unsecured debt in the approved amount (e.g., $20K) and to generate a lien on the subject property for the corresponding converted amount.

Generating a lien includes generating typical documentation that may be recorded with a Registry of Deeds, for example. If the Registry of Deeds accommodates electronic recordal of liens (as a third party system 130), then lien manager 420 automatically accomplishes such, otherwise the lien may be recorded by traditional hardcopy means. Debt conversion manager 412 may be configured to generate a message to mortgage account manager 320, which stores information regarding the existence of the lien (and its amount) in DB 141 and associates it with the client's accounts against the subject property.

Along with making payment, the UDC system may also facilitate any necessary notifications to interested third parties, such as the creditor of the previously unsecured debt or lenders that also have liens against the subject property, as examples. In some embodiments, the UDC system may be configured to notify lenders when liens are to be removed, based on payment of the converted debt. In such a case, the UDC system may check the status of payment of the secured debt automatically, from time-to-time, or in response to a client's request.

Still, in other embodiments, particularly when the UDC system is integrated or interfaced with the AAEL system (described in Part 1), an equity loan may be generated to payoff some or all of the unsecured debt, thereby creating secured debt of a corresponding amount. If an equity line of credit exists, then the line of credit may provide the proceeds to pay the unsecured debt, and the equity line of credit may be increased if necessary. In addition to potential tax advantages, this type of conversion may be particularly useful when the interest rate on the equity loan is less than the interest rate on the unsecured debt loan.

Additionally, the UDC system, using functionality from the AAEL system, may be configured to reduce an available line of credit on an existing equity loan to reflect a new lien. For example, if there is an equity line of credit of up to $50K existing for a subject property and the debt to be converted is $20K, upon generation of a lien for and payment of $20K to secure the previously unsecured debt, the resulting available line of credit is adjusted to $30K.

If the debt conversion opportunity is being pulled by the client, the UDC system may request the client input relevant account and lien information related to the subject property and the unsecured debt to be converted. If the client has initiated the request for debt conversion (i.e., it was pulled), this interaction may be accomplished in real-time via a Web site interface. If the debt conversion opportunity is being pushed, the UDC system may seek unsecured debt information and equity information from third parties and, if a debt conversion opportunity exists, the UDC system may alert the client via, for example, e-mail using alert generator 414. In either case, the UDC system may request relevant information or verify such information from third party information providers, such as credit reporting agencies and financial services institutions.

The debt conversion opportunity may also be pushed to the client, i.e., UDC system may periodically or as a function of certain other parameters determine whether the client has existing unsecured debt and whether any of such debt may be converted. In such a case, the opportunity may be provided via an e-mail alert initiated by alert generator 414. The client may then access the corresponding financial services institution's Web site to facilitate the conversion, again preferably in real-time. As an example, the equity determination manager may periodically query credit-reporting agencies to determine whether the client has existing credit card debt (or other unsecured debt) and, if so, determine the equity in the client's home. If there is equity and the unsecured debt can be converted the client is contacted (via e-mail, phone, mail, or other means). In other embodiments, the UDC system may be configured to allow clients to register for alerts of debt conversion opportunities.

For example, as will be appreciated by those skilled in the art, the UDC functionality may be made available to clients as a service offered by a financial institution, wherein the client may assent to debt conversions or lien removals in advance and receive notifications when such events transpire. For example, the client may register for a service wherein anytime a certain credit card has a balance over $1K, the UDC system should attempt to convert the amount above $1K to secured debt. Otherwise, the client may receive notifications of the existence of such opportunities. When conversion is triggered automatically, triggering criteria and logic are included in the UDC system.

Part 4. Rapid Close Conforming Loan System and Method

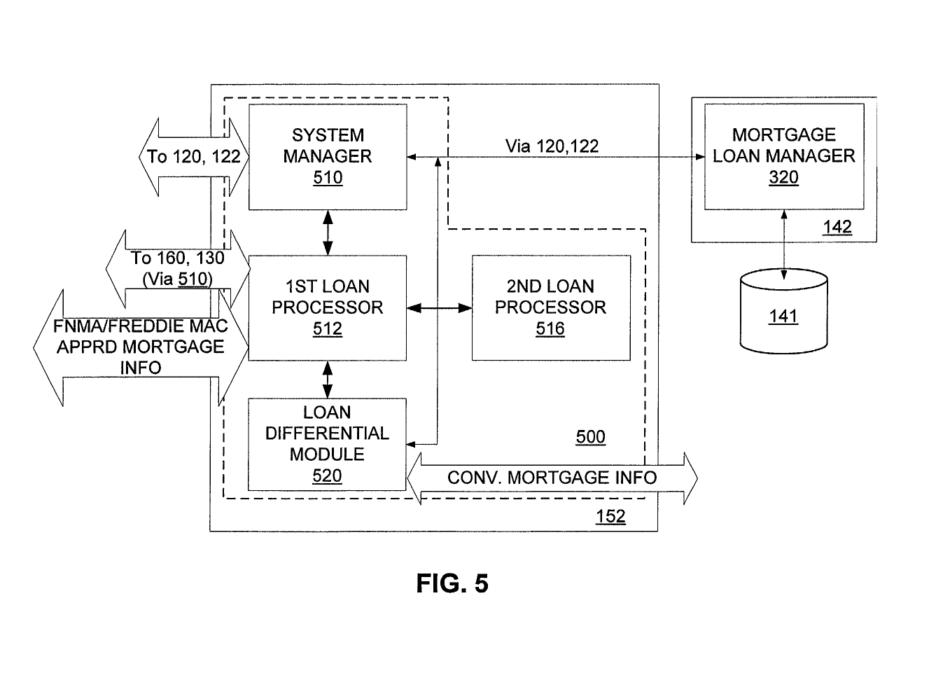

A system and method for rapid close of a conforming loan (i.e., “the rapid close (RC) system”) in accordance with the present invention may be appreciated with respect to FIG. 1A, FIG. 1B, FIG. 1C, and FIG. 5. That is, the RC system may be implemented using the basic architecture 190 of FIG. 1A or the architecture 192 of FIG. 1B, for example, and is particularly useful in a real property context. The RC system allows automated generation of a conforming loan that is guaranteed in terms of loan amount and interest rate, based on automated property valuation. The basic functionality of the RC system may be embodied in an RC application 500 (see FIG. 5). Using architecture 190 of FIG. 1A, RC application 500 may be hosted by an application system 150. In other embodiments, RC application 500 may be hosted on account management system (e.g., system 140), as shown in FIG. 1B. As will be appreciated by those skilled in the art, the RC system may be hosted on any of a variety of architectures and the various systems, servers, and DBs used may be collocated or remote to each other (or some combination thereof) and each subsystem (e.g., 124, 140, 150, and 160) may be controlled by different entities or service providers.

For illustrative purposes, the RC system will be described with respect to architecture 190 of FIG. 1A, wherein the RC application 500 is hosted on application system 150. In such an embodiment, the AAEL system application 200 is optional and when included may be included on server 152 or one a different server (not shown), for example. Like the AAEL system of Part 1, the functionality of RC system may be accessed via a Web server 126 (as part of a network interface system 124 that may also include a DB 125). A client may interface with a Web site hosted by Web server system 124, which is responsible for the generation of Web pages in response to the client's interaction, wherein Web server 126 passes functional and content related requests to servers 132, 142, 152 and 162, as required.

In the context of the RC system, the financial account server 142 includes a typical mortgage account manager module (or application) 320 that administers underlying mortgage(s) stored in DB 141. In the illustrative embodiment, the account management server 142 is that of a first lender seeking to provide a first mortgage to a client seeking to purchase a piece of real property. RC application 500, hosted on server 152, includes a system manager 510 that manages interfaces, directs the basic tasking, and otherwise administers the RC application 500.

Upon a request for a loan (and mortgage) via the Internet 120, for example, system manager 510 tasks a first loan processor 512 to determine a client's eligibility for a loan for a subject property. Given the address of the subject property, the 1^{st} loan processor 512 (or system manager 510) tasks the property valuation system 160 to determine the market value of the subject property (i.e., to perform an automated appraisal). Preferably in real-time a property valuation is returned to 1^{st} loan processor 512. Using the automated property valuation, 1^{st} loan processor 512 applies various guidelines (e.g., FNMA/Freddie Mac Guidelines), credit and other financial information related to the client, and interest rate information to determine whether the requested loan would be a conforming loan for the subject property. Such information and guidelines may be provided by third party systems 130. If the client is eligible, the 1^{st} loan processor 512 approves a guaranteed loan amount and interest rate and notifies the client in real-time of such.

If the first lender accepts an automated property valuation, the guaranteed loan can be closed. However, as a consequence of the requirement by many lenders for a traditional appraisal of the subject property, in many situations an appraiser is required to visit the subject property to conduct the traditional appraisal before the loan can be closed. In such a case, the loan can not be closed rapidly, but it is guaranteed by the RC system rapidly based on satisfaction of required LTV ratio with respect to the automated property valuation. The loan is guaranteed in terms of loan amount and interest rate. Based on the outcome of the traditional home appraisal, one of at least two scenarios may occur. First, the traditional appraisal yields a property value sufficiently high so that the required FNMA/Freddie Mac LTV ratio is satisfied and the loan is considered to be “conforming”. Otherwise, the traditional appraisal yields a property valuation wherein the required LTV ratio (e.g., ≦80%) is not achieved and the loan is considered to be “non-conforming”. The lower the LTV ratio using the real-time property valuation (e.g., where a buyer is intending on borrowing only 50% of the property valuation amount) the lower the risk that the loan will be non-conforming once the traditional appraisal is complete. The RC system accommodates each scenario.

Scenario 1. Traditional Appraisal, Loan Conforming

In the first scenario, even with the traditional appraisal, the loan is conforming. For example, assuming the required LTV ratio is a max of 80%, if property valuation system 160 returns a property valuation of $200K, the borrower requests a purchase loan of $160K, and the traditional appraisal is $205K, the LTV ratio is less than 80%, so the loan conforms. In such a case, the first lender provides a first conventional conforming mortgage loan to the client, and a loan is closed at the previously guaranteed amount and interest rate. To accomplish this, the RC system receives an indication, via system manager 510 for instance, that the loan conforms and the 1^{st} loan processor 512 processes the loan. The 1^{st} loan processor 512 of the RC system passes the loan information to the mortgage account manager 320, which establishes and administers an account corresponding to the new loan.

Scenario 2. Traditional Appraisal, Loan Non-Conforming

In the second scenario, the traditional appraisal is less than the automated property valuation, so the loan does not conform. For example, assuming the required LTV ratio is a max of 80%, if property valuation system 160 returns a property valuation of $200K, the borrower requests a purchase loan of $160K, and the traditional appraisal is $195K, the I,TV ratio is greater than 80% using the traditional appraisal, so the loan does not conform. The traditional appraisal amount is provided to loan differential module 520, which calculates the maximum loan amount for a conforming loan. Under this scenario, a loan amount of not more than $156K would be conforming. The first lender prepares to give the client a first conventional conforming loan of $156K at the guaranteed interest rate. Therefore, a $4K shortfall between the guaranteed loan amount of $160K and the conforming loan amount of $156K exists.

The shortfall amount (i.e., $4K in this scenario) and the guaranteed interest rate are provided to a 2nd loan processor 516. The 2nd loan processor is preferably configured to query other lenders willing to enter a second loan, and take a second mortgage, for the subject property in the amount of the shortfall. For illustrative purposes, assume the guaranteed interest rate is 9.0%. Of possible second lender candidates, the 2nd loan processor 516 determines a second lender based on the most favorable interest rate, i.e., an interest rate less than (e.g., 8.5%) or equal to the guaranteed interest rate (e.g., 9.0%) would be preferable. If the most favorable interest rate available is greater (e.g., 9.5%) than the guaranteed rate (e.g., 9.0%), the net present value (PV) of the shortfall amount given the difference between the two interest rates (0.5%) is determined. As will be appreciated by those skilled in the art, up front payment of the net PV given the difference between interest rates yields a loan at the desired interest rate. In this scenario, up front payment of the net PV of 0.5% for $4K would yield a second loan having a principle amount of $4K at an interest rate of 9.0%, in accordance with the guarantee. This up front payment may be paid by the first lender, as part of a service offering real-time guaranteed conforming loans, may be forgiven by the second lender, if an appropriate alliance between the first and second lender exists, as examples. Optionally, the first lender may also choose to lower the interest rate on the first loan, such the an effective interest rate over the guaranteed amount is still achieved.

The first conventional conforming loan and the second loan are then offered to the client and closed. As a result, the client receives from the first lender (in conjunction with the second lender) the guaranteed loan amount of $160K (e.g., $156K+$4K) at the guaranteed interest rate (or effective interest rate) of 9.0%. The first loan is managed by the first lender and the second loan may be managed by the second lender. In another embodiment, for the convenience of the client, the first lender may build the payment of the second loan into the required monthly payment (and bill) of the first loan and the first lender may then pay the second lender from those proceeds. In other embodiments, an independent party may guarantee the loan and accept payment from the client, pay any net PV due, and/or pay either of the first or second lenders or both.

Part 5. Automated PMI Removal System and Method

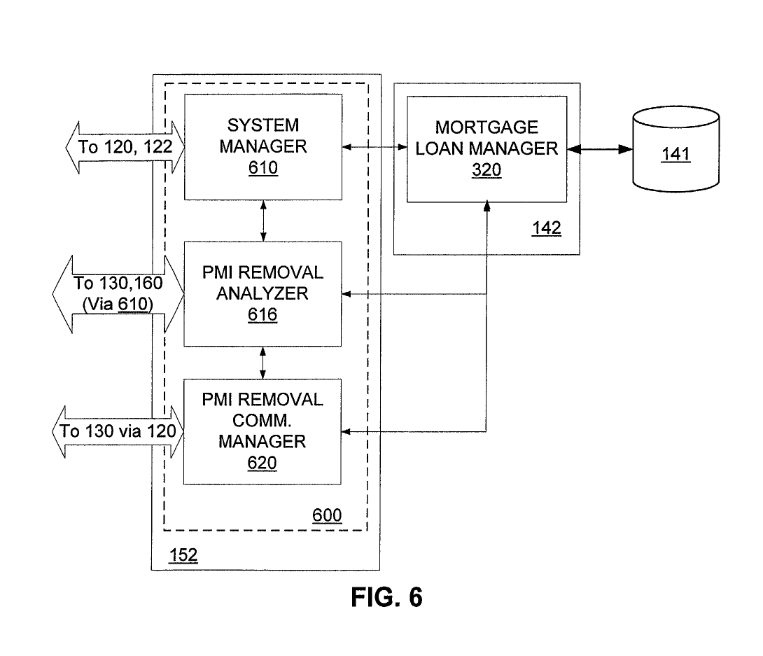

The automated private mortgage insurance (PMI) removal system and method in accordance with the present invention may be appreciated with respect to FIGS. 1A, 1B, 1C and 6. Typically, when a client purchases a subject property and at the time of purchase the equity in the subject property is less than 20% of its appraised value, the client (e.g., the homeowner) is required to pay for PMI. Typically, the PMI payment is built into the client's monthly mortgage payment (i.e., collected with the mortgage payment) and administered by a first lender that holds a first mortgage on the subject property. Once 20% equity is achieved, the PMI may be “removed”. Some lenders require the lapse of an initial period (e.g., 2 years) from the date of closing the loan before the PMI is eligible for removal. However, typically clients are not aware of the point in time when 20% equity is achieved.

An automated PMI removal system may be implemented on either of the basic architectures 190, 192, or 194 of FIGS. 1A, 1B, or iC, respectively. Using FIG. 1A as an illustrative embodiment, a PMI removal system includes a PMI removal application 600 (see FIG. 6) hosted on application system 150, and also includes (or has access to) an account management system 140, a property valuation system 160 and a network interface system 124. Preferably, network interface system 124 provides Web access to the functionality of the PMI removal application 600. Additionally, the PMI removal system may include interfaces to third party systems and data, such as other financial institutions, credit reporting agencies, lenders and so on. As will be appreciated by those skilled in the art, the PMI removal system may be hosted on any of a variety of architectures and the various systems, servers, and DBs used may be collocated or remote to each other (or some combination thereof) and each system (e.g., 124, 140, 150, and 160 ) may be controlled by different entities or service providers.

The account management server 142 hosts a typical mortgage loan account manager module (or application) 320 that administers a client's underlying mortgage loan and PMI accounts. Information regarding the loan and PMI accounts is stored in DB 141. The PMI removal system may be implemented to analyze PMI removal opportunities with respect to mortgage loans maintained by account management system 140 of a third party mortgage company or bank, as examples. A PMI removal service provider may independently assess PMI removal opportunities for a client regardless of which lender holds the client's underlying first mortgage.

The PMI removal application 600, hosted on server 152, includes a system manager 610 that manages interfaces, directs the basic tasking, and otherwise administers the PMI removal application. Also included is a PMI removal analyzer 616 that tasks property valuation system 160 to return a current market value for the subject property. The property valuation system 160 is described in Part 1, and requires a subject property address as an input. The PMI removal analyzer 616 also retrieves the current outstanding mortgage loan balance(s) against the subject property, either from account management system 140 or from a third party system (e.g., system 130 ), depending on the lender that holds the mortgage(s). DB 151 may contain guidelines for removing PMI or such guidelines may be obtained from another source, but are preferably retrievable automatically and in real-time by the PMI removal system.

Given the property valuation, current mortgage loan balance(s), and PMI removal guidelines, the PMI removal analyzer 616 determines whether the amount of equity in the subject property is sufficient to give rise to a PMI removal opportunity. For example, if the property valuation is $200K, the current balance on the outstanding mortgage against the subject property is $157K and the guidelines require at least 20% equity to remove PMI, then a PMI removal opportunity exists. If there is a required time period lapse from the original closing date before PMI can be removed, the PMI removal analyzer also determines whether such time period has lapsed, since even if sufficient equity exists in the subject property there will not be an opportunity to remove PMI under the existing mortgage until the required time has lapsed. The PMI removal system may also be configured to offer a refinancing opportunity to the client if the required time period has not lapsed. As will be discussed in greater detail below, the PMI removal application 600 may be triggered in a variety of manners (e.g., pushed or pulled).

If the loan qualifies for removal of PMI, a PMI removal communication manager 620 generates and sends a notification to the mortgage provider (e.g., account management system 140) to discontinue PMI and the client is so notified. In such a case, the mortgage loan account manager 320 receives the notification and adjusts the account and billing information for the loan accordingly. If the mortgage loan is held and serviced by a third party, the notification is, preferably, provided to the third party system 130 via the Internet 120 and, similarly, the client's account is updated to reflect the removal of PMI. From that point forward, the client no longer pays PMI on the mortgage loan.

The process for evaluating and removing PMI may be triggered in any of a variety of manners and the existence of such an opportunity may be “pushed” to or “pulled” by the client (i.e., property owner). An opportunity is pushed to a client when the holder of the first mortgage (or another service provider) triggers the process and communicates the PMI removal opportunity to the client. The process may be triggered periodically (e.g., monthly) or according some other predetermined schedule. In such cases, an alarm may be set to trigger the process and reset after each time the process completes. In other cases, the process may be triggered based on a variety of other factors (e.g., a rise in property values), which may also include alarms. In any case, the process may be triggered automatically, wherein triggering criteria and logic are included in the PMI removal system (e.g., within system manager 610).

A PMI removal opportunity is pulled when the client solicits an evaluation and/or removal of PMI from a lender or other service provider. For example, the client may enter a Web site of the first mortgage holder, input the address for a subject property and solicit the real-time removal of PMI. As part of triggering the evaluation of such an opportunity, the client may assent to having the PMI removed as part of the initial request, if such an opportunity is determined to exist.

In somewhat of a hybrid approach, a lender or other service provider may offer a service for evaluating a client's opportunity to remove PMI, if and when possible. In this case, a client may register for the service and receive a notification (e.g., e-mail message or alert generated by PMI removal communication manager 620) when a PMI removal opportunity exists. Otherwise, the client may assent to the automatic removal of PMI upon registering for the service and receive a notification when such removal has occurred with, preferably, an indication of the resulting adjusted monthly payment to be made to the lender. If the PMI removal system is configured to recommend a refinancing opportunity when a required time period has not yet elapsed, then such opportunities may also be pushed or pulled.

Part 6. Property Rating & Ranking System and Method

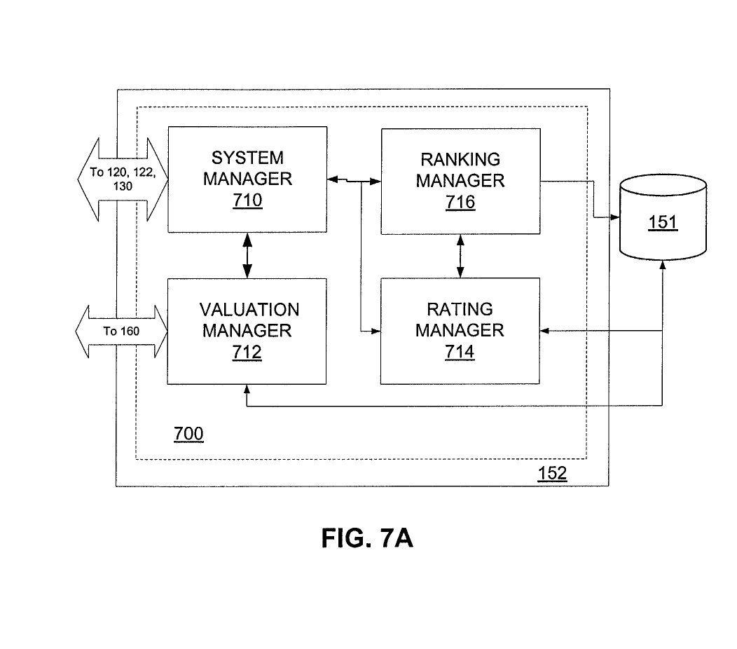

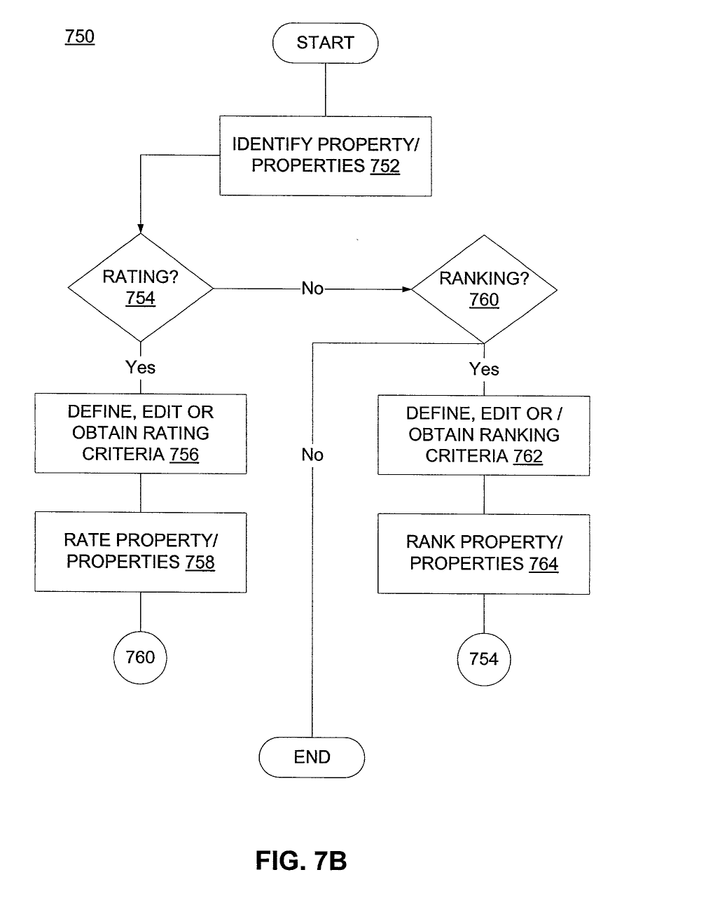

A property rating and ranking (R&R) system and method in accordance with the present invention may be appreciated with respect to FIGS. 1A, 1B, 1C, 7A and 7B. The property R&R system, such as a real property R&R system, provides analysis and ultimately a rating and/or ranking of a list of candidate properties of interest to a client. The candidate list may be a set of client defined properties, a set of R&R system returned properties, or some combination thereof. “Rating” a property involves assessing the property against a defined set of rating criteria and providing some objective rating indicia based on the assessment (e.g., the property is rated an “A” or a “Good Deal” or given a gold star). Rating criteria may be weighted differently or uniformly. “Ranking” a candidate list involves ordering the candidate list of properties according to one or more of a defined ranking criteria, wherein ratings may serve as ranking criteria. Rating and ranking of an individual property can be performed against a wider set of properties, such as similar properties in a market of interest. Among other things, such rating and ranking information is useful in objectively evaluating buying opportunities.

The property R&R system may be implemented on the basic architectures 190, 192, or 194 of FIGS. 1A, 1B or 1C, respectively. In the illustrative embodiment, the property R&R system is implemented on the architecture 194 of FIG. 1C and includes a R&R application 700 (see FIG. 7A) hosted on application system 150 and accessible via the Web through network interface system 124. An R&R method may be embodied in R&R application 700 is shown in FIG. 7B, as flow chart 750. An interface to a property valuation system 160 is provided as is an interface to systems configured to provide listing information, such as multi-listing service (MLS) real estate information. Such listing information may be provided by a third party system 130 and includes information related to aspects of one or more candidate properties being offered for sale (e.g., price, condition, and/or size). In the embodiments of FIG. 1A and 1B, the R&R application 700 may be hosted on system 130 or 140, as examples.

The R&R application 700 includes a system manager 710 that manages interfaces, directs the basic tasking among managers, and otherwise administers the R&R application 700. As an example, a client may request ratings of one or more properties the client is considering buying, preferably via a Web site interface. As part of the client's request, the client may define one or more candidate property criteria. The candidate property criteria may correspond to any of a variety of typical property related listing information, such as price, number of bedrooms, town, lot size, state school system ranking, tax rate, demographics and so on. Preferably, the Web site presents functionality that facilitates ease of criteria definition by the client, such as customary Web site radio buttons, drop down lists, and other graphical mechanisms.

A candidate list of properties is identified, step 752 of FIG. 7B, under the control of system manager 710. Using the Web site interface, a client may enter a request for the R&R system to return a list of candidate properties. The request may be completely defined at the start of a session or it may be iteratively built. For example, the client may first seek a listing of all properties between $200K and $250K in Lexington, Mass., which may yield a list of condos and single family homes. System manager 710, queries sources to obtain properties substantially satisfying the candidate property criteria. Once that group has been returned, the client may narrow the search to only single family homes. Once that group has been returned, the client may further narrow the list of candidate properties to only 3 bedroom single family homes. Ultimately, the client achieves a list of candidate properties to be rated and/or ranked. The candidate list will typically include at least basic listing information, including address and list price.

If the client is interested in one or more specific properties already known to the client, the client may define those properties by entering the addresses of those properties into the R&R system. If the client entered specific property addresses, the R&R system may query other systems to obtain information (e.g., typical listing information) useful in rating or ranking the candidate list. The R&R system using listing information related to client entered addresses, may be configured to form a set of candidate property criteria and to perform a query to find additional candidate properties. In such a case, the client's candidate list may be augmented with these additional candidate properties.

During the rating and/or ranking process, the client may have the option to enter or override the list price of candidate properties and have rating and/or ranking performed using the client's entered price. This may be particularly useful if a client is attempting to determine an offer price for a subject property, based on the rating and/or ranking. As will be appreciated, it is not required that property information be provided from MLS listings, it may come from other sources, including sellers, buyers, brokers, classified ads, and so on provided by one or more third party systems 130.

The client may request that the list of candidate properties be rated, ranked, or both. The list of candidate properties may contain as few as one property. If the client requests that the properties be rated, step 758, system manager 710 tasks rating manager 714 to rate the candidate properties using rating criteria. The rating manager 714 may evaluate candidate properties based on predefined or client defined criteria, step 756. Predefined rating criteria may be system defined standard criteria (or templates) or they may be industry accepted (or institutionalized) rating criteria. The R&R system templates are defined, when provided, to reflect customary buyer and seller considerations. To accommodate any special considerations of a buyer or seller, the R&R system may allow the client to define its own rating criteria, based in typical data found in real estate listings, for example. Where a plurality of client rating criteria are defined, the client may be given the option to weight each of the rating criterion.

Furthermore, in some embodiments, the property R&R system (e.g., the system manager 710) may derive weighting for client defined rating criteria based on client information or client responses to system prompts. For instance, the property R&R system may present a variety of questions to the client and based on the responses to those questions, a weighting of rating criteria may be determined, and possibly provided to the client as optional recommendations. For example, the property R&R system may obtain client information that the client is married with three children of ages 4, 6, and 8 years old. From this client information, the R&R system may determine that quality and proximity to schools should be weighted highly. Additionally, based on such questions, the R&R system may determine and/or recommend client-rating criteria, such as quality and proximity of schools. Such questions, client information, and weighting may also be stored in DB 151.

Frequently, one or more rating and/or ranking criteria will be related to automated property valuations. In that case, a valuation manager 712 requests the current valuation for each property from the property valuation system 160. The system manager 710 obtains the candidate list and tasks the valuation manager 712 to obtain an automated property valuation for each candidate property. As an example, given candidate property criteria, such as single family homes, 3 bedrooms in Lexington, Mass., ≦$250K, the following list may be formed:

1) 25 Main Street, List Price of $250K, Valuation of $250K

2) 13 Oak Street, List Price of $225K, Valuation of $220K

3) 100 Garden Street, List Price of $215K, Valuation of $230K

In the illustrative example, the client may request that the candidate properties get rated according to a rating criterion of percentage of list price to the valuation of the property (e.g., P%=List Price/Valuation×100; Rating of “A” if 90%<P<95%, “B” if 95%<P<100%, and “C” if P>100%), wherein:

1) 25 Main Street, Rating=B

2) 13 Oak Street, Rating=C

3) 100 Garden Street, Rating=A

Rating symbols or indicia need not be of the form A, B, and C; they could be any of a number of symbols or conventions (e.g., 5 star rating) that communicates an assessment relative to a set of rating criteria. In some embodiments, the actual rating need not be displayed, for example, where only the top rated property is to be indicated, such as:

Top rated property is: 100 Garden Street

The client may request ranking of a set of rated or unrated properties, step 760, according to one or more objective ranking criteria. However, when candidate properties have been rated, rating may serve as a ranking criteria. In any case, the ranking criteria are defined, step 762, and passed to the ranking manager 716, which ranks the candidate list of properties according to the ranking criteria, step 764. Like rating criteria, ranking criteria may be predefined, as system templates or institutionalized, client defined, some combination thereof. The ranking criteria may be multi-level, wherein the properties are ranked according to a first level criteria (e.g., property rating) and then within each level according to a next level criteria (e.g., lot size). Although not necessary, one or more of the rating and ranking criteria maybe the same. When rated properties are also ranked, the ranking may be presented with or without the property ratings. Continuing the former example, ranking the rated candidate list of properties according to their ratings gives the following ranking:

1) 100 Garden Street, Rating=A

2) 25 Main Street, Rating=B

3) 13 Oak Street, Rating=C

As briefly mentioned above, rated and ranked properties may be further ranked by additional ranking criteria, i.e., multi-level ranking criteria. For example, if the candidate list included a fourth property, e.g., 7 Elm Street, again a 3 bedroom single family house in Lexington, Mass. listed at $235K that was also rated an “A” and was closer to the town high school than the Garden Street home, and the additional criteria (with property rating still being the first ranking criteria) is proximity to the high school, the ranked list becomes:

1) 7 Elm Street, Rating=A

2) 100 Garden Street, Rating=A

3) 25 Main Street, Rating=B

4) 13 Oak Street, Rating=C

In such a case, system manager 710 may provide the property addresses to a third party mapping system or tool to determine and return geographic distances, for example.

However, rated properties need not be ranked by their rating. For example, if for the properties above, 13 Oak Street was the closest to the high school and 25 Main Street was the most distant, and the only ranking criteria was proximity to the high school, the ranked list would be:

1) 13 Oak Street, Rating=C

2) 7 Elm Street, Rating=A

3) 100 Garden Street, Rating=A

4) 25 Main Street, Rating=B

As mentioned previously, candidate properties need not have been rated at all to be ranked. In such a case, the valuation manager 712 passes candidate list and ranking criteria to the ranking manager 716, which performs the ranking according to the ranking criteria. After ranking, the candidate list properties may also be rated. Using the previous candidate list with proximity to the high school as the lone ranking criteria, the ranked list becomes:

1) 0.5 miles, 13 Oak Street, List Price of $225K

2) 0.7 miles, 7 Elm Street, List Price of $235K

3) 1.7 miles, 100 Garden Street, List Price of $215K

4) 3.3 miles, 25 Main Street, List Price of $250K

In the case above, the distance from the high school (e.g., . 5 miles) and price are optionally provided. Although, in most scenarios, how each candidate property relates to the ranking criteria is useful and price is nearly always considered useful information in comparing properties.

As another example, the client may choose to have the candidate list of properties ranked by dollar difference between valuation and list price (e.g., Difference=Valuation−List Price). Assuming that the property valuations and list prices of the other properties are as previously defined and the Elm Street property has a valuation of $240K, the ranked list is:

1) 100 Garden Street, Difference=$15K

2) 7 Elm Street, Difference=$5K

3) 25 Main Street, Difference=$0K

4) 13 Oak Street, Difference=−$5K

In another example, properties could be ranked according to percentage of list price to automated valuation, wherein the lower percentages (i.e., lower price relative to valuation) are ranked higher. The ranked list could be:

1) 100 Garden Street, Difference=93%

2) 7 Elm Street, Difference=98%

3) 25 Main Street, Difference=100%

4) 13 Oak Street, Difference=102%

Properties may also be rated and or ranked relative to the market, which may be user defined or system defined (e.g., by town and property type). As an example, a single family home could be ranked #1 in lowest percentage of list price to valuation, among all single family homes in Lexington Mass. As will be appreciated by those skilled in the art, rating and/or ranking can be performed according to any of a number of criteria and presented in any of a number of manners (e.g., lists, graphs, charts, etc.).

Part 7. Property Evaluation & Alert System and Method

A property evaluation and alert (E&A) system and method in accordance with the present invention may be appreciated with respect to FIGS. 1A, 1B, 1C, 7A, 7B, and 8. A property E&A system, such as a real property E&A system, allows a client (e.g., a buyer) to enter a set of candidate property criteria and receive automated alerts when one or more candidate properties substantially satisfying the candidate property criteria is located. In the preferred form, the client establishes an account with the property E&A system and receives alerts via e-mail. The E&A system may be combined with the property R&R system described in Part 6 and may include one or more of the same components, as discussed in more detail below.

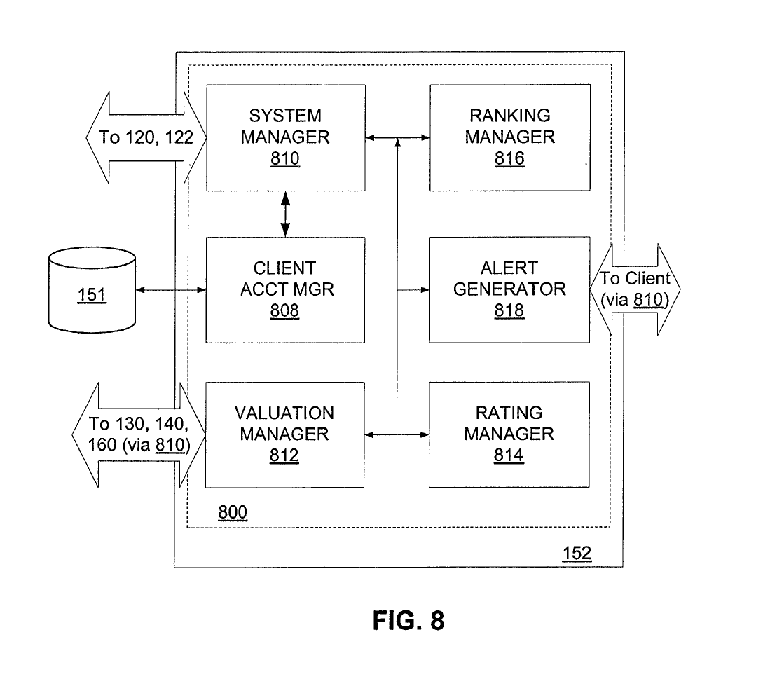

A property E&A system, such as a real property E&A system, may be implemented on the basic architecture 190, 192, or 194 of either of FIGS. 1A, 1B or 1C, as examples. In the illustrative embodiment, the E&A system is implemented on the architecture 194 of FIG. 1C and includes an E&A application 800 (see FIG. 8) hosted on application system 150 and accessible via the Web through network interface system 124. An interface to property valuation system 160 is provided as is an interface to systems configured to provide listing information, such as multi-listing service (MLS) real estate information. Such listing information may be provided by a third party system 130 and includes information related to aspects of one or more candidate properties being offered for sale (e.g., price, condition, and/or size). In the embodiments of FIGS. 1A and 1B, the E&A application 800 may be hosted on account management server 142 or (in the case of FIG. 1C) application server 152, as examples.

The E&A application 800 includes a system manager 810 that manages interfaces, directs the basic tasking among managers, and otherwise administers the E&A application 800. As an example, using a Web site interface, hosted on network server 126, a client may establish a request to be alerted when and if one or more properties satisfying a set of candidate property criteria is located. The criteria may include a town, type of dwelling (e.g., single family home, condo, cooperative, townhouse, or multifamily), a target or maximum price, number of bedrooms, etc. In some embodiments the criteria may include a certain minimum or preferred rating, wherein the rating is a function of a set of rating criteria as described in Part 6. Additionally, the property E&A system may include functionality to rank properties according to a set of ranking criteria as described in Part 6.

In the preferred form, the E&A application 800 also includes a client account manager 808. The client account manager 808 accepts and may prompt the client for account information necessary to establish (or update) an account, such account information may include the client's name, e-mail address, candidate property criteria, rating criteria, preferred minimum rating, and/or ranking criteria, as examples. This account information may be stored in DB 151.

The E&A system manager 810 may query other systems and DBs, such as providers of typical listing information (e.g., MLS information) to find candidate properties substantially satisfying at least a subset of the candidate property criteria. Listing information may be provided by one or more third party systems 130. Assuming a list of candidate properties has been returned to property E&A system, and if rating criteria have been defined, the candidate properties are rated by a rating manager 814. The rating manager 814 is substantially the same as rating manager 714 described in Part 6 with respect to FIG. 7A and FIG. 7B. Properties not meeting a minimum required rating, as defined by the rating criteria, may be dropped from the candidate list. If more than one property remains on the candidate list, the properties may be ranked, particularly if the client requested ranking and provided ranking criteria.

Ranking is performed by ranking manager 816, which is substantially the same as the ranking manager 716 described in Part 6 with respect to FIG. 7A and FIG. 7B. The ranking manager 816 may be used to rank a candidate list of properties, regardless of whether or not the candidate list has been rated. For instance, the candidate list of properties may simply be ranked by price. However, if property rating is a ranking criterion, each property must be rated before ranking can be performed. In the preferred form, indicia corresponding to the candidate list of properties and any ratings and/or rankings performed are stored in DB 151 and associated with the client's account.

When one or more properties substantially satisfying the client's candidate property criteria is located, an alert generator 818 generates, preferably, a corresponding e-mail alert message to the client. The alert message may include the candidate list and information related to any rating and/or ranking performed or may simply invite the client to check his account to find new information. Preferably, using the Web site, the client can further rate and/or rank the candidate list of properties by adding, deleting or modifying rating and ranking criteria. In some cases, this may cause new properties to be added to the candidate list and/or other properties to be dropped from the candidate list. Preferably, such alerts and modifications occur in real-time.

An entity may own and/or operate the property E&A system and offer such alerts to clients under a service agreement. As such, constraints may be placed on the frequency with which the property E&A system queries sources for properties satisfying the client's criteria. For example, one level of service may offer continuous checking, 24 hours a day, 7 days a week, while another (i.e., less expensive) level of service may offer checking once a day, 7 days a week. In other embodiments, a client may be charged based on the number of properties identified. Yet, in other embodiments, the client may be charged a fee based on the price of a property purchased from the candidate list, or a flat fee for service, or a monthly service charge. As will be appreciated by those skilled in the art, the property E&A system may be implemented in a variety of business methods to the benefit of clients and service providers.

Part 8. Seller-Based Property Rating System and Method

A seller-based property rating (SPR) system and method in accordance with the present invention may be appreciated with respect to FIGS. 1A, 1B, 1C, 7A and 7B. The SPR system, such as a real property SPR system, provides a client seller with the capability to analyze its property (i.e., a subject property) in terms of current, substantially objective market data. By doing so, the client seller can determine how its subject property would be rated at different price points or with different features, which may prove useful in determining a list price for the subject property. The client seller may use the rating and/or ranking functionality of the SPR system to help assess or determine the benefit of certain contemplated home improvements in the relevant market (e.g., the addition of a garage, a pool, or hardwood floors or the upgrade of a kitchen) by having the subject property rated and/or ranked as through those improvements existed.

In one embodiment, a standard set of institutionalized ratings may be formed, against which all properties may be rated and those achieving a certain minimum rating may be given an industry standard designation, something akin to a seal of approval, as an institutionalized rating system, as described with respect to FIG. 7A and 7B. For instance, standards may be established and ratings given as a function of a subject property's list price versus property valuation, as determined, for example, by property valuation system 160. In one embodiment, a property having a list price equal to or below the corresponding property valuation may be given a favorable “Good Deal”, gold star, or “A” designation, for example.

An SPR system may be implemented on the basic architecture 190, 192, or 194 of FIGS. 1A, 1B, or 1C. In the illustrative embodiment, the SPR system is implemented on the architecture 194 of FIG. 1C. In such an embodiment, the SPR system may be substantially identical to that described with respect to FIG. 7A and 7B. Therefore, with regard to FIG. 7A, an SPR application 700 may include a system manager 710, a valuation manager 712, a rating manager 714 and/or a ranking manager 716 hosted on application system 150. The client seller defines its subject property by entering traditional real estate listing information into an SPR system via a Web site interface. System manager 710 stores the subject property information in DB 151. Valuation manager 712 retrieves the subject property information and tasks property valuation system 160 to provide an automated property valuation for the subject (i.e., the seller's) property.

With the subject property information and automated property valuation, the SPR system allows a client seller (or an agent thereof) to obtain a property rating and/or ranking for the subject property. A favorable rating and/or ranking may be used to help market the subject property. Upon request, the property rating manager 714 determines a rating for the subject property, just as a rating was determined for properties on behalf of the buyer in Part 6. The rating criteria may be an industry-accepted (i.e., institutionalized) rating criteria, although it is not essential. Furthermore, when ranking manager 716 is included, the client seller may have the subject property ranked relative to similar competing properties in the client seller's market. The client may define, or the SPR system may derive from the subject property information, a set of criteria that is used to obtain a list of competing properties from sources having typical listing information. The ranking criteria may be predefined or client defined, as described with respect to the R&R system of Part 6.

Part 9. Relocation Alert System and Method

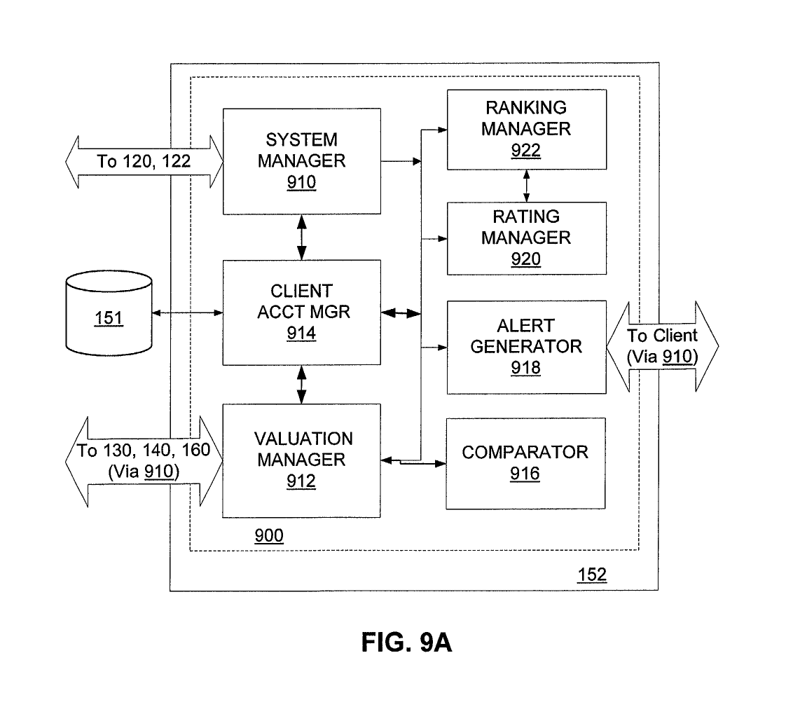

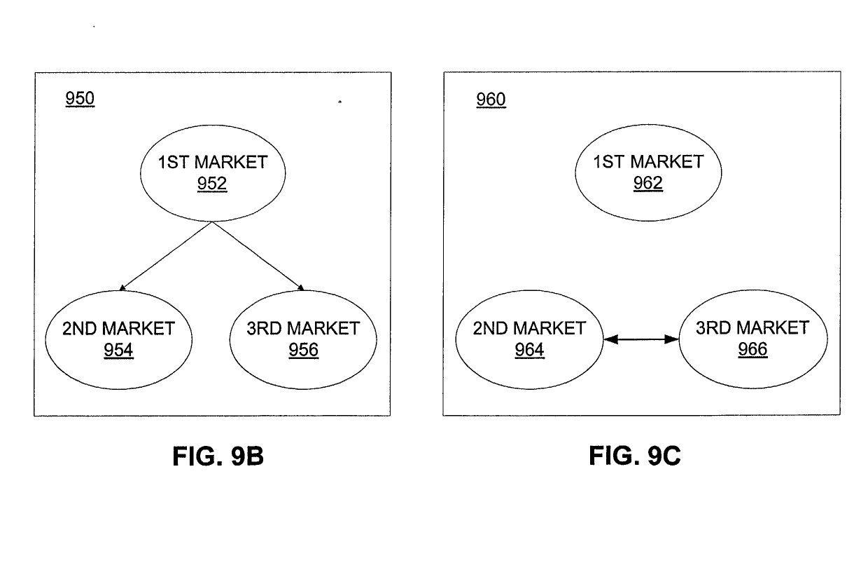

A relocation alert (RA) system and method in accordance with the present invention may be appreciated with respect to FIGS. 1A, 1B, 1C, 7A, 7B, 8, and 9 A-C. The RA system provides a client (e.g., an individual interested in selling and/or buying a piece of real property) with a capability to evaluate, or to have evaluated, buying opportunities in a second market or market segment (collectively, “second market”) relative to a first market or market segment (collectively, “first market”). In an illustrative embodiment, the client desires to compare the desired second market with the current first market that includes the client's present property. The client seeks to be alerted to an optimal time to transition from the first market to the second market. In other embodiments, the RA system is used to evaluate two or more next markets, without regard to a first market (see FIGS. 9B and 9C). The RA system may be used to evaluate opportunities to relocate within the same market.

Markets may be defined in a variety of manners. For example, a market may define a certain geographic location, a certain tier (e.g., a price range) in a given geographic location, a certain type of property regardless of geographic location, a property of a certain rating and/or ranking, or some combination of these or other parameters. For example, a client may compare condominiums in a metropolitan area with single-family homes in a suburb of that metropolitan area. The client may compare condominiums in a town with single family homes in the same town. As another example, a client may compare condominiums in Boston, Mass. with condominiums in Manhattan, N.Y. In some embodiments, the RA system may be configured to compare several (i.e., more than 2) markets, and each market may be defined differently. What is of importance is the change in identified parameters in one market with respect to changes in identified parameters in the other market(s), as discussed in further detail below. To facilitate comparison, the client enters evaluation criteria related to the parameters.

An RA system may be implemented on any of the basic architectures 190, 192, or 194 of FIGS. 1A, 1B or 1C, respectively. In the illustrative embodiment, the RA system is implemented on architecture 194 of FIG. 1C and includes an RA application 900 (see FIG. 9A) hosted on an application system 150, accessible via the Web, and a property valuation system 160. In other embodiments, using the architectures 190 or 192 of FIGS. 1A or 1B, RA application 900 may be hosted on system 130 or 140. Generally, the RA system may be implemented as an extension of an E&A system, such as that described in Part 7, and may include one or more of the same components, as discussed in more detail below. Additionally, the RA system may include one or more components of an R&R system, such as that described in Part 6, as discussed below.

The RA application 900 includes a system manager 910 that manages interfaces, directs the basic tasking among managers, and otherwise administers the RA application 900. As an example, a client trying to relocate may (via a Web site interface) identify his property in the first market 952 to the system and identify a set of candidate property criteria, which are indicative of or define a second market 954, as is shown in the market relationship 950 of FIG. 9B. As is also shown in FIG. 9B, a third (or more) market 956 may also be defined, where the client is considering transitioning to one of a group of markets. As is shown in the market relationship 960 of FIG. 9C, the client can compare a second market 964 with a third market 966, without regard to a first market 962.

The candidate property criteria for a market may include the town (or other geographic region), type of dwelling (e.g., single family, townhouse, condominium, etc.), a target or maximum price or price range, number of bedrooms, and so on. The client's information (e.g., the client's identification, the client's current address, the market-based candidate property criteria and evaluation criteria) may be established using a client account manager 914 and may be stored in DB 151, wherein system manager 910 tasks the client account manager 914 to establish the client's account. Where there are additional potential markets, beyond the second market, the candidate property criteria may differ among markets.

Additionally, as described in Parts 6 and 7, the client's candidate property criteria may include rating criteria and/or ranking criteria. For example, compare A rated condos with A or B rated single family homes. Optionally, depending on the embodiment of the RA system, the client may define, as an evaluation criteria, a desired spread between the market value (or automated property valuation) of the client's current property and candidate properties (or a representative candidate property) in the desired second market. In such cases, the spread criteria may be represented as a percentage or as a dollar amount. Therefore, the candidate property criteria for second market 954 may include common listing information (e.g., Lexington, Mass., single family home, 3 bedrooms, 1.5 baths, $200K-$250K). The evaluation criteria may include rating criteria, ranking criteria, and/or relative (e.g., spread) criteria. The evaluation criteria are used to compare parameters between the client's current property (or first market) and the candidate properties (or second market), as in the spread criteria defined above, according to FIG. 9B.

The RA system is preferably configured to track markets of interest (e.g., first, second, and/or third markets) over time. Therefore, the RA system, preferably performs evaluations from time to time of the markets of interest and when the client's candidate property and evaluation criteria are satisfied, the RA system alerts the client. To perform an evaluation, valuation manager 912 tasks the property valuation system 160 to provide a current valuation for the client's current property. Using the candidate property criteria, the system manager 910 obtains a candidate property list. To obtain the candidate property list, system manager 910 queries various available sources to gain information on candidate properties. Such information may include multi-listing service (MLS) information, for example, and may be provided by third party systems 130.

Having obtained, for example, a candidate property list of Lexington, Mass., single family home, 3 bedrooms, 1.5 baths, $200K-$250K properties, the RA system manager applies the evaluation criteria to determine if it is appropriate to alert the client. If the client defined a spread criteria, comparator 916 is tasked to compare a certain parameter (e.g., property valuation) of each candidate property with the client's current property valuation to determine if the spread is achieved. That is, typically, the automated property valuation of the candidate property will be compared to the automated property valuation of the client's current property. However, in some embodiments, a parameter of the candidate property (e.g., property valuation) may be compared to a parameter not tied to the current property. As an example, the RA system may be configured to compare property valuation of one or more candidate properties to cost of living within the second market and alert the client when an optimal relationship exists. Or, the RA system may be configured to compare a plurality of parameters between markets, e.g., the property valuation and cost of living in the second market with property valuation and cost of living in the first market. As will be appreciated by those skilled in the art, there are a variety of ways in which to compare markets and/or properties within markets.

If the client requested to have properties in a second market rated, the system manager 910 passes the candidate list to the rating manager 920 for rating in accordance with Part 6. If a rating was part of the criteria for comparing the second market with the first market, the rated candidate list is passed to the comparator 916. If the client also requested a ranking of candidate properties, the candidate list is also passed to a ranking manager 922 for ranking in accordance with Part 6. The system may also be configured to rate and/or rank a plurality of markets (rather than individual properties in those markets) under consideration by the client.

In other embodiments, the valuation manager 912 is configured to form a representative candidate property, derived from the list of candidate properties. As described with respect to other processes in various parts herein. In such a case, rather than using actual candidate properties for evaluation, a representative property is defined for each market of interest. The representative properties are used to evaluate markets (see Part 10). The evaluations by the RA system may be triggered in any of a variety of manners; they may be pushed or pulled.

Part 10. Relocation Forecasting System and Method

A relocation forecasting and alert (RF) system and method in accordance with the present invention may be appreciated with respect to FIGS. 1A, 1B, 1C, 7A, 7B, 9 A-C, and 10. An RF system, such as a real property RF system, may be used by a client to have forecasted an optimal time to relocate from one market or market segment (collectively, “first market”) to another market or market segment (collectively, “second market” ), based on a variety of criteria. The client's property may be defined to the RF system along with criteria for a candidate (i.e., next) property (i.e., candidate property criteria) in one or more markets of interest (e.g., the second market). Using the candidate property criteria and other relevant information (e.g., trend data in the relevant markets), the RF system forecasts an optional time for the client to market its current property in the first market (if the client owns in the first market) and pursue a new property in the second market, i.e., to transition from one market to another. The client need not be restricted to the second market, but rather may have the first market compared to several markets. Also, the client can use the RF system to compare or evaluate two or more potential next markets without regard to the first market, see FIG. 9A and FIG. 9B.

Markets may be defined in a variety of manners. For example, a market may define a certain geographic location, a certain tier (e.g., a price range) in a given geographic location, a certain type of property regardless of geographic location or some combination of these or other parameters. For example, a client may compare condominiums in a metropolitan area with single-family homes in a suburb of that metropolitan area. As another example, a client may forecast the optimal time to transition from a condominium in Boston, Mass. to a condominium in Manhattan, N.Y. Or, a client may compare condominiums and single family homes in the same town.

A hypothetical representative property may be defined that reflects an average of similar properties meeting the candidate property criteria in the markets (e.g., 3 bedroom, 1.5 bath, single family home, less than 30 years old, in Lexington, Mass.) being evaluated. Otherwise, an actual representative property in each market may be chosen as being indicative thereof. In the first market, the client's property may serve as the representative property. Where there are several potential next markets defined (as in FIG. 9A and FIG. 9B) there may be different candidate property criteria and a different representative property for each market. Forecasts may be made with respect to the client's property (as a representative property of the first market) and the representative property of each other market.

The RF system may provide analysis over a forecast period continuously or at certain intervals. A continuous analysis provides a continuous (preferably viewable) data set over the entire forecast period. A forecast period and intervals may be defined in any of a variety of manners. For example, a client may wish a forecast over the next 18 months, with 1 month intervals. The RF system may also be configured to give a one-time forecast, e.g., during a current session. The RF system may also be configured to provide updated or new forecasts from time-to-time, in which case establishment of a client account may be performed. When updated forecasts are to be provided, those updates may be triggered in any of a variety of manners, such as periodically, upon a relevant event, or upon client request, as examples. In such cases, the RF system analyzes, preferably, changes in automated property valuation of properties in each market being evaluated, each month through the 18 month period. Whether continuous or at intervals, the forecast data may be generated from market data using known math modeling techniques. Furthermore, forecasts may be pushed to clients or pulled from clients.

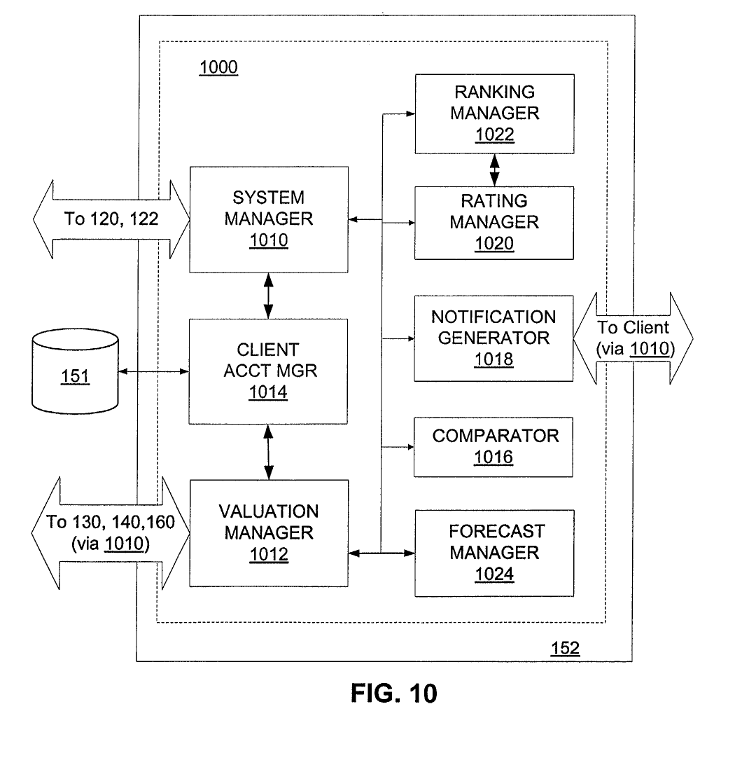

A RF system may be implemented on any of the basic architectures 190, 192, or 194 of FIGS. 1A, 1B or 1C, respectively. In the illustrative embodiment, the RF system is implemented on the architecture 190 of FIG. 1A and includes an RF application 1000 (see FIG. 10) hosted on an application system 150, accessible via the Web, and a property valuation system 160. The RF system may be implemented as an extension of or include an interface to a real property RA system, such as that described in Part 9 and may include several of the same or similar components, as discussed in more detail below. Additionally, the RF system may include one or more components or may be interfaced with a property R&R system, such as that described in Part 6, as discussed below.

The RF application 1000 includes a system manager 1010 that manages interfaces, directs the basic tasking among managers, and otherwise administers the RF application 1000. As an example, a client interested in relocating may (via the Web 120) input information defining the client's property (“client property information”), such as typical listing information to the RF system. The client also enters, for each possible next market, a set of candidate property criteria. The candidate property criteria may include the town, type of dwelling, a target or maximum price or price range, number of bedrooms, and so on (e.g., Lexington, Mass., single family home, 3 bedrooms, 1.5 baths, $200K-$250K). Candidate property criteria may also include rating and/or ranking criteria. The client may also enter client account information (e.g., the client's identification, and contact information, including e-mail address), so that a client account may be established using a client account manager 1014. The client account information, client property information, candidate property criteria, and evaluation criteria may be stored in DB 151. System manager 1010 tasks the client account manager 1014 to establish the client's account, which may be session-based or persisted in memory.

The client may enter evaluation criteria, which may include rating criteria and/or ranking criteria, using rating manager 1020 and/or ranking manager 1022 as described in Parts 6 and 7. Optionally, depending on the embodiment of the RF system, the client may define an evaluation criteria of a desired (e.g., minimum or maximum) spread between property valuations of the markets of interest. In such cases, the spread criteria may be represented as a percentage or as a dollar amount. As an example, the client may task the RF system to determine when within the next two years (e.g., a forecasting period) the % spread between the property valuation of the client's property and the average property valuation for candidate or representative properties in the second market is less than 10%.

The valuation manager 1012 uses the candidate property list to obtain a property valuation from property valuation system 160 for each candidate property. Comparison between markets may be facilitated by obtaining an average or median property valuation for a list of candidate properties in each market or for a representative property in each market. Determination of the average or median property valuation may be accomplished in a variety of manners. Using the client's property information the system manager 1010 may derive a set of client property criteria for the first market. System manager 1010 may also query systems and sources of listing information (e.g., MLS information) and obtain a list of candidate properties in the first market. Using the candidate property criteria for each other market, the system manager 1010 obtains a candidate list for each market. For each candidate property, the valuation manager 1012 sends property information (e.g., property address, number of bedrooms, number of bathrooms, etc.) to the property valuation system 160, which returns an automated property valuation. The valuation manager 1012 determines an average property valuation for each market using the candidate property automated property valuations.

In another form, or as an additional feature, the client's property may serve as a representative property in the first market, and an automated property valuation may be obtained. For example, the client's property and valuation may be:

18 Maple Street, Plymouth, Mass., Valuation=$200K

And the candidate list and valuations may be:

1) 13 Oak Street, Lexington, Mass., Valuation=$220K

2) 7 Elm Street, Lexington, Mass., Valuation=$240K

3) 100 Garden Street, Lexington, Mass., Valuation=$230K

With a candidate average automated valuation of: $230K.

Forecasting, is accomplished by a forecast manager 1024 and may be accomplished using math modeling techniques known to those skilled in the art. Preferably, forecast manager 1024 forecasts the market value of the client's current property and the average automated valuation of properties in the markets of interest satisfying the candidate property criteria at each forecast interval over the forecast period and stores them in DB 151. The forecasts may be made in a variety of manners, but preferably involves using valuation trend data for each market of interest and applying that trend data prospectively to each forecast interval in each market, to forecast a valuation for each property on the candidate list or to forecast a valuation for a representative property in each market of interest. In the latter case, the forecast valuations for the candidate properties may be averaged at each forecast interval to arrive at a forecast average market value at each interval in each market of interest.

For example, assume the forecast period is 12 months and the forecast interval is 3 months, the forecasted valuation for the client's current property may be:

Month 0: 18 Maple Street, Plymouth, Mass., Valuation=$200K

Month 3: 18 Maple Street, Plymouth, Mass., Valuation=$207K

Month 6: 18 Maple Street, Plymouth, Mass., Valuation=$202K

Month 9: 18 Maple Street, Plymouth, Mass., Valuation=$201K

Month 12: 18 Maple Street, Plymouth, Mass., Valuation=$200K

And, the forecasted average valuation for the candidate properties in a second market may be:

Month 0: Candidate Average Valuation: $230K

Month 3: Candidate Average Valuation: $235K

Month 6: Candidate Average Valuation: $235K

Month 9: Candidate Average Valuation: $236K

Month 12: Candidate Average Valuation: $237K

Once these determinations are complete, a valuation comparator 1016 determines at each interval the optimal time for the client to transition. This determination can be made in any of a variety of manners, such as dollar amount (minimum or maximum) spread or spread percentage. Other criteria may be used to compare markets of interest. For example, market activity (e.g., number of houses sold or time on market at each interval) or the relationship of a variety of trends that may or may not each be directly related to the markets (i.e., unemployment trends, cost of living trends, interest rate trends, etc.) may be used. For instance, a client may consider it more favorable to move when interest rates are at their lowest, even if the dollar amount spread is not at its minimum. Assuming that the client has requested to have the first and second markets compared relative a minimum spread between property valuations between markets, the valuation comparator 1020 determines:

Month 0: Valuation Spread: +$30K

Month 3: Valuation Spread: +$28K

Month 6: Valuation Spread: +$33K

Month 9: Valuation Spread: +$35K

Month 12: Valuation Spread: +$37K

In such a scenario, the client is interested in transitioning when the spread is smallest, i.e., in month 3. Comparator 1024 provides these results to the client, preferably in real-time via the Internet using notification generator 1018. As is apparent, if a different client is determining the best time to transition from the second market to the first market, the forecast interval with the largest spread is best, i.e., month 12.

If the client has registered for a service, for example, to receive updates of the analysis or alerts when the optimal time in the forecast period is approaching or arrived, such updates and notices are also provided by notification generator 1018. If the present time is the optimal time to transition, such notices may include a candidate list of properties in the second market, for example.

Also, as will be appreciated by those skilled in the art, when rating and/or ranking functionality is included or made accessible by the RF system 194, the client may define any of a variety of rating and/or ranking criteria which may be used, as an example, to influence the formation of a candidate list of properties in the second market or evaluations between markets.

Part 11. Property Tradeoff System and Method

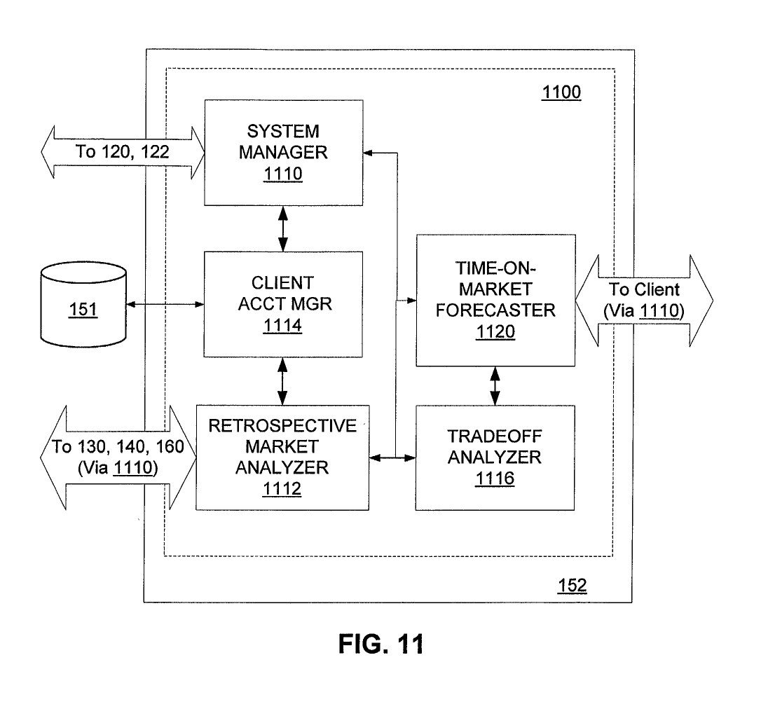

A property tradeoff (PT) system and method in accordance with the present invention may be appreciated with respect to FIGS. 1A, 1B, 1C, and 11. The PT system aids a client, typically a seller, in determining a list price for a subject property (e.g., real property) based on a variety of parameters. The PT system assists the client by, for example, accumulating and presenting market data that allows a client to make tradeoffs between asking (or list) price (relative to a market value or valuation) versus time on market (TOM). Differences between list price and valuation are expressed as percentages in the illustrative embodiment, but may be expressed in other ways in other embodiments. Therefore, given a valuation for the subject property, the client can predict the TOM at different list prices.

A PT system may be implemented on any of the basic architectures 190, 192, or 194 of FIGS. 1A, 1B or 1C, respectively. In the illustrative embodiment, the PT system is implemented on the architecture 194 of FIG. 1C and includes a PT application 1100 (see FIG. 11) hosted on an application system 150, accessible via a Web interface. The PT system includes an interface to property valuation system 160. In other embodiments, using the architectures of FIGS. 1A or 1B, PT application 1100 may be hosted on system 130 or 140.

The PT application 1100 includes a system manager 1110 that manages interfaces, directs the basic tasking among managers, and otherwise administers the PT application 1100. As an example, a client may (via the Web 120) input information that identifies a subject property (i.e., “subject property information”). Subject property information may be typical listing information, such as property address, type of dwelling, number of bedrooms, and so on (e.g., 13 Oak Street, Lexington, Mass., single family home, 3 bedroom, 1.5 bathrooms, $220K). A subject property list price is preferably not required, since the client will determine list price based on results provided by the PT system. From the subject property information, the system manager 1110 derives corresponding “comparable property criteria” (e.g., single family home, 3 bedroom, 1.5 bathrooms).

If the client is seeking a one-time tradeoff analysis, during a single session, the subject property information may be saved in short-term memory, and potentially only saved during the client's session. If the client seeks, or has established, a long-term relationship with the PT system, the client also enters client information, such as personal and contact information stored long term (i.e., persisted) in DB 151. The client information (including the subject property information) is stored in DB 151 using a client account manager 1114, wherein system manager 1110 tasks the client account manager 1114 to establish the client's account.

The PT application 1100 includes a retrospective market analyzer 1112 configured to search relevant systems (e.g., a third party system 130 and property valuation system 160) historical sales data for properties sold within a certain period of time and for a certain geographic area (or market, as previously defined). Preferably, the search is tailored to find comparables for homes substantially satisfying the comparable property criteria. The returned historical sales data (which may be publicly or privately made available) includes for each property, as an example, identification of a sold property, its list price and date, and its selling price and date sold. For example, assume the relevant period was the year 2000 and the relevant geographic area includes Lexington, Mass., the following list may be returned:

1) 25 Main Street, Lexington, Mass., List Price $275K, Listed Feb. 28, 2000, Sale Price=$255K, Sold Jun. 30, 2000

2) 7 Elm Street, Lexington, Mass., List Price=$240K, Listed May 15, 2000, Sale Price=$240K, Sold Jul. 15, 2000

3) 100 Garden Street, Lexington, Mass., List Price=$225K, Listed Aug. 24, 2000, Sale Price=$233K, Sold Aug. 30, 2000

4) 3 Pine Street, Lexington, Mass., List Price=$250K, Listed Aug. 1, 2000, Sale Price=$250K, Sold Aug. 30, 2000

System manager 1110 tasks property valuation system 160 to obtain a current automated valuation for each property.

Given such information, the retrospective market analyzer 1112 determines a retrospective valuation for each property at the date it went on the market. Each property's automated valuation may be regressed to determine a retrospective property valuation.

In a simpler form, the sale price of each property may be used as the property valuation at the list date (or as an estimated property valuation). As one alternative, the property valuation system 160 may maintain or be capable of calculating past valuation data and, in response to a request from PT application 1100, return a valuation using the data that was current when the property being evaluated went on the market. As another alternative, retrospective valuation may be obtained by adjusting the current automated property valuation as a function of economic data, such as an index of the deflation or inflation in property prices in that geographic region between the current date and the date the property went on the market.

An automated property valuation may be determined retrospectively or regressed in a variety of manners using historical data and characteristics. There are many such techniques known in the mathematical and statistical arts which involve taking the types of data used to calculate a current property valuation, but instead using the data that would have been used under the valuation methodology had the valuation been done at that earlier point in time. As an example only , regression using historical sales data may be accomplished by using comparables in each month and, for like properties sold in the selected month, averaging the sale prices. The average sale price could be adjusted to account for any of a variety of (positive or negative) factors. For example, such factors may include adjustments for condition, lot size, age of property, extra or fewer bedrooms or bathrooms, and so on. This may be represented by the equation: Retrospective Valuation=Avg Sale Price [1+(Sum of Factors)]. For example, if the average sale price of 3 bedroom, 1.5 bathroom homes in Lexington, Mass. for May 2000 was $230K and the property at 7 Elm Street had an attached 2-car garage as an “extra” (which had an adjustment factor of 0.045), the retrospective valuation for 7 Elm Street, Lexington, Mass. would be

=$230K[1+(0.045)]

=$240K

For each property above, the following information may be generated:

1) 25 Main Street, Lexington, Mass., Retrospective Valuation on Feb. 28, 1999=$250K

2) 7 Elm Street, Lexington, Mass., Retrospective Valuation on May 15, 1999=$240K

3) 100 Garden Street, Lexington, Mass., Retrospective Valuation on Aug. 24, 1999=$236K

4) 3 Pine Street, Lexington, Mass., Retrospective Valuation on Aug. 1, 1999=$255K

A tradeoff analyzer 1116 determines which properties were sold for asking (i.e., list) price and ranks them according to a percentage difference between the asking price and retrospective valuation. For example, the properties above that sold for asking price may be ranked as follows:

1) 7 Elm Street, Lexington, Mass., Listed @ 100% of Valuation, Sold @ 100% of Valuation

2) 3 Pine Street, Lexington, Mass., Listed @ 98% of Valuation, Sold @ 98% of Valuation

For each ranked property, a TOM forecaster 1120 determines the TOM and correlates this time period to the ranking for the property. For example,

1) 7 Elm Street, Lexington, Mass., 100%/100%, TOM=67 days

2) 3 Pine Street, Lexington, Mass., 98%/98%, TOM=30 days

This information is presented to the client in a meaningful format (e.g., list, table or graph) and from this information the client may determine that it is desirable to price the subject property below market value to sell it quickly (as in case Z). Using the initial client entered subject property information (e.g., 13 Oak Street, Lexington, Mass., single family home, 3 bedroom, 1.5 bath), the PT system tasks the property valuation system 160 to return a property valuation (e.g., $230K). The client enters a proposed list price for the subject property and the tradeoff analyzer 1116 uses the valuation and list price to determine and return a TOM and/or a predicted sale price, as follows:

Analysis: 13 Oak Street, Lexington, Mass., Listed @ $220K, 95% of Valuation, Predicted to sell @ $223K, TOM=10 days

Any of a variety of known prediction models may be used. The client may enter different list prices and receive different TOM and/or sale price predictions. The PT system may also provide a graphical representation showing % (List Price over Valuation) versus TOM, wherein the client may visually view the TOM at various list prices, and wherein an input list price is not required for the subject property to generate the data for such a graph.

Additionally, tradeoff analyzer 1116 may use data for properties listed and/or sold below or above asking price, such as:

3) 100 Garden Street, Lexington, Mass., Listed @ 95% Valuation, Sold @ 99% Valuation

4) 25 Main Street, Lexington, Mass., Listed @ 110% Valuation, Sold @ 103% Valuation

For each property the TOM forecaster 1120 determines the length of time each of such properties spent on the market, correlates this time period, and ranks the properties as a function of lowest TOM. For example (where % List/% Valuation is given),

3) 100 Garden Street, Lexington, Mass., 95%/99%, TOM=7 days

4) 25 Main Street, Lexington, Mass., 110%/103%, TOM=123 days

Ranking the comparable properties based on lowest TOM generates a complete list as follow:

1) 100 Garden Street, Lexington, Mass., 95%/99%, TOM=7 days

2) 3 Pine Street, Lexington, Mass., 98%/98%, TOM=30 days

3) 7 Elm Street, Lexington, Mass., 100%/100%, TOM=67 days

4) 25 Main Street, Lexington, Mass., 110%/103%, TOM=123 days

From this information the client may determine that it is most advantageous to list the subject property below market value (case 1, at 95%) and potentially generate immediate interest and possibly have the sale price bid up by competing buyers and have a quick sale. The client can also glean that pricing the subject property above market value (case 4, at 110%) may get a sale price above the market value (i.e., 103% of the valuation), but at an expense of having the property on the market significantly longer than if the property were listed at or below market value.

As will be appreciated by those skilled in the art, the various data may be used in variety of manners to assist a client in determining a desirable list price with respect to a projected TOM at a selected list price, typically relative to an objective valuation. Additionally, the PT system may be configured to account for changes in list price during the time the property is listed on the market. In such a case, the PT system may include a first model for performing tradeoff analysis where the list price of the previously sold homes used as historical data were not adjusted between the initial listing and the sale. Additional models may also be included for those situations where list prices were changed. Additionally, the PT system may be configured to make adjustments based on current or prospective changes in the market from a variety of factors (e.g., economic, social, political).

Additionally, the PT system may include forecasting functionality (or an interface to a forecasting system, such as that described in Part 10) to facilitate prospective tradeoff analysis. For example, if the client lists the subject property 6 months from today, the property valuation will be “X” and if listed at 0.98X (i.e., at a list price that is 98% of X), the TOM will be “Y”.

Part 12. Broker Evaluation System and Method

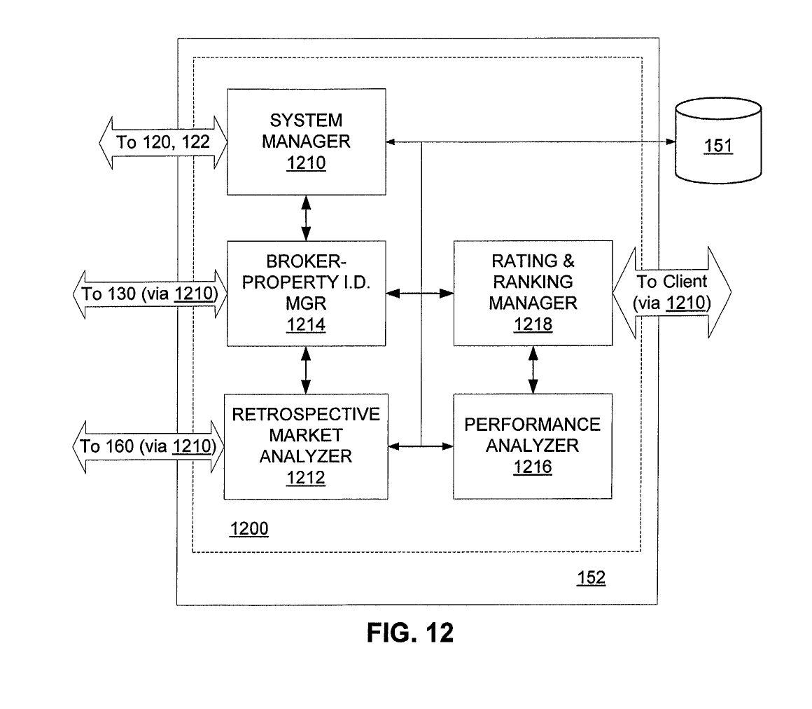

A broker evaluation (BE) system and method in accordance with the present invention may be appreciated with respect to FIGS. 1A, 1B, 1C, and 12. A BE system may be used by clients (e.g., sellers or buyers) to identify in real-time one or more candidate brokers and/or agents (collectively “brokers”) to be used to sell or buy, as the case may be, a subject property. For example, a client buyer may use the BE system to find a buyer's broker and a client seller may use the BE system to find a seller's broker. Preferably, the BE system facilitates the client's selection of a broker based on past performance of the broker, and possibly past performance relative to other brokers in the relevant market or market segment. For example, a broker's performance may be based on various performance criteria, such as sale price, list price, time on market (TOM) or based on a weighted combination of the foregoing. In each case, the performance criteria may be relative to a property valuation.

A BE system may be implemented any of the basic architectures 190, 192, or 194 of FIGS. 1A, 1B, or 1C, respectively. In the illustrative embodiment, the BE system is implemented on the architecture of FIG. 1C and includes a BE application 1200 (see FIG. 12) hosted on an application system 150, accessible via a Web interface. An interface to a property valuation system 160 is also included. In other embodiments, the BE application 1200 may be hosted on system 130 or 140.

The BE application 1200 includes a system manager 1210 that manages interfaces, directs the basic tasking among managers, and otherwise administers the BE application 1200. As one example, a client may (via the Web 120) identify a list of candidate brokers for comparison and choose to have them rated and/or ranked according to performance criteria (e.g., TOM, or % of sale price versus valuation). Additionally, in some embodiments, the client may input property criteria for the subject property and have analysis provided over properties fitting the property criteria. The request is received by the system manager 1210 and a broker-property I.D. manager 1214 is tasked to search relevant databases or systems (e.g., third party system 130, such as MLS databases) to identify all relevant properties over a certain period of time listed by each candidate broker. If property criteria are included, they may also be used in the search, such that each property on the list of properties returned satisfies the property criteria.

For example, in a seller's broker scenario, if the client defined a subject property as Lexington, Mass., single family home, 3 bedrooms, 1.5 baths, a retrospective market analyzer 1212 may return the following historical data:

1) Broker, Mary Smith

A. 25 Main Street, Lexington, Mass., List Price=$275K, Listed Feb. 28, 1999, Sale Price=$255K, Sold Jun. 30, 1999

B. 9 Elm Street, Lexington, Mass., List Price=$259K, Listed May 15, 1999, Sale Price=$240K, Sold Aug. 15, 1999

2) Broker, John Jones

A. 100 Garden Street, Lexington, Mass., List Price=$225K, Listed Aug. 24, 1999, Sale Price=$233K, Sold Aug. 30, 1999

B. 3 Pine Street, Lexington, Mass., List Price=$250K, Listed Aug. 1, 1999, Sale Price=$250K Sold Aug. 30, 1999

Given such information, the retrospective market analyzer 1212 determines a retrospective valuation for each property at the date it went on the market. The retrospective valuation can be determined (or regressed) in a variety of manners, such as was described in Part 11. For each property above, the following information may be generated:

1) Broker, Mary Smith:

A. 25 Main Street, Lexington, Mass., Retrospective Valuation on Feb. 28, 1999=$250K

B. 9 Elm Street, Lexington, Mass., Retrospective Valuation on May 15, 1999=$240K

2) Broker, John Jones

A. 100 Garden Street, Lexington, Mass., Retrospective Valuation on Aug. 24, 1999=$236K

B. 3 Pine Street, Lexington, Mass., Retrospective Valuation on Aug. 1, 1999=$255K

For each broker and each property, a performance analyzer 1216 determines performance based on the chosen performance criteria. If the performance criteria include TOM and the percentage of list price to retrospective valuation, for example, the following information is determined:

1) Broker, Mary Smith:

A. 25 Main Street, Lexington, Mass., Listed @ 110%, Sold @ 102% of Valuation, TOM=123 days

B. 9 Elm Street, Lexington, Mass., Listed @ 108%, Sold @ 98% of Valuation, TOM=67 days

2) Broker, John Jones

A. 100 Garden Street, Lexington, Mass., Listed @ 95%, Sold @ 99% of Valuation, TOM=7 days

B. 3 Pine Street, Lexington, Mass., Listed @ 98%, Sold @ 98% of Valuation, TOM=30 days

This information may be presented to the client and based thereon, the client may determine that Mary Smith gets the higher sale price, but John Jones sells the house more quickly.

A rating & ranking manager 1218 may be included to rate and/or rank the brokers relative to each other, or relative to a set of industry standards. In an illustrative case, assume that brokers are rated according to an industry standard, wherein % of list price to valuation and TOM are used as rating criteria. In other cases, % of sale price to list price may be used, as another example. In a situation where shortest average TOM is weighted more heavily than % list price to valuation, assume that John Jones has an average TOM of 18 days and Mary Smith has an average TOM of 95 days. Also assume that according to standards, an average TOM of ≦30 days receives an “A” rating, an average TOM of 31≦60 days receives a “B” rating, an average TOM of 61≦90 days receives a “C” rating, and an average TOM of >90 days receives a “D” rating. Ranking (or ordering) brokers by rating yields the follows:

1) John Jones, Rated “A”

2) Mary Smith, Rated “D”

In a situation where % of sale price to valuation is weighted more heavily than TOM, the brokers may be rated as follows:

1) Mary Smith, Rated “A”

2) John Jones, Rated “B”

Even if not rated, brokers may be ranked relative to one or more ranking criteria, such as shortest TOM. For example,

1) John Jones, Ranked #1

2) Mary Smith, Ranked #2

In addition to, or as an alternative to being ranked relative to brokers returned in the initial search, brokers may also be ranked relative to their peers, generally. For example, in the relevant market with regard to TOM:

1) John Jones, Ranked #7

2) Mary Smith, Ranked #56

As will be appreciated by those skilled in the art, when the client is a buyer seeking a buyer's broker, the criteria may vary. However, the buyer may also wish to have brokers ranked according % of purchase price to market valuation. As will also be appreciated by those skilled in the art, other criteria and data may also be included, such as customer satisfaction criteria. Furthermore, the client may be provided with functionality to adjust and redefine any of the criteria and have results provided in real-time.

Part 13. Property Guaranteed Valuation System and Method

A property guaranteed valuation (PGV) system and method in accordance with the present invention may be appreciated with respect to FIGS. 1A, 1B, 1C, 10, and 13. The PGV system provides for the wrapping of a guarantee or insurance policy around a forecasted default valuation (DV) for a subject property. Using the PGV system, a client or lender (as a beneficiary) can obtain a guarantee from a guarantor (e.g., insurance company) that a future sale price at foreclosure, for example, will not be less than the forecasted DV at a given point in time within a guarantee period. Therefore, if the subject property is sold at foreclosure for less than the guaranteed DV, the guarantor pays the beneficiary the difference.

In the illustrative embodiment, the PGV system is implemented on the architecture 190 of FIG. 1A. The PVG system includes or has access to a property valuation system 160 for obtaining automated property valuations for a subject property and may also include or have access to the RF system of Part 10. One or more account management systems 140 may be included, i.e., one for a lender and/or mortgage company (collectively, “lender”) and one for a guarantor. An application system 150 is included and one or more third party systems 130 may also be included. Third party systems 130 may be used to provide relevant market, credit, financial, or other data, whether past or present. These various systems may be coupled together in any of a variety of manners, but in FIG. 1A they are coupled together via a network interface system 120 (which may host a Web site interface).

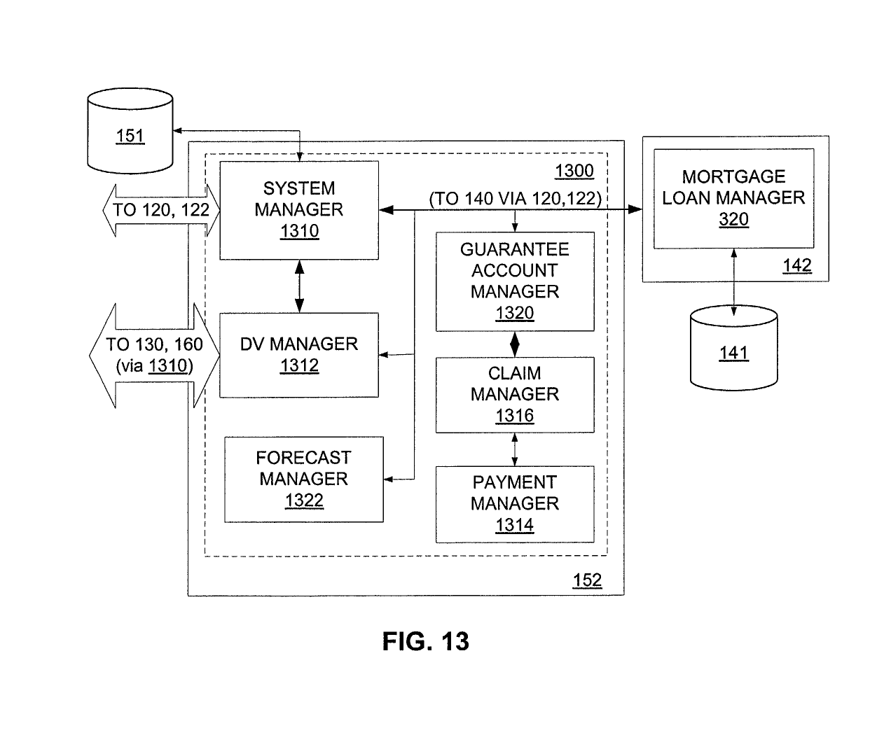

In the illustrative embodiment, a PGV application 1300 (see FIG. 13) is hosted on application system 150 and may access the account management system 140 and third party systems 130 as needed. Account management system 140 hosts a mortgage loan account manager 320 of the lender that administers the underlying mortgage loan(s) of a client (e.g., owner of the subject property). RF system functionality may also be hosted on application system 150, or may be hosted on a third party system 130. The PGV application 1300 includes a system manager 1310 that manages interfaces, directs the basic tasking among managers, and otherwise administers the PGV application 1300. Account management system 140 includes an account manager 320, which administers the client's underlying mortgage(s). A guarantee account manager 1320 is shown as part of the PGV application 1300 and hosted in application system 150, but may be part of a third party system 130. Account manager 1320 manages the guarantee policy account. A claim manager 1316, and a payment manager 1314 are also included, as described in further detail below.

As an example, at the time of a mortgage loan application by the client to borrow to purchase the subject property, or to borrow against the subject property, the lender uses the PGV system to obtain a guarantee of DV for the subject property for a guarantee period. The address of the subject property and the guarantee period are submitted to system manager 1310, and stored in DB 151. Other subject property information may also be entered that describes the subject property in terms of typical listing information. Depending on the embodiment, system manager 1310 may query property valuation system 160 for a current automated property valuation. Otherwise, system manager 1310 tasks DV manager 1312 to query property valuation system 160 for the automated property valuation. The property valuation system 160 may be part of the overall PGV system 1300 or may be provided by an independent provider and accessed by the PGV system.

The PGV application 1300, as mentioned, may access an RF system (see Part 10) or may include a forecast manager 1322, which forecasts property valuations for the subject property for the guarantee period. That is, system manager 1310 may derive from the subject property information a set of property criteria consistent with typical listing information and forecast manager 1322 forecasts property valuations using relevant historical sales data and known predictive models and techniques. Forecast manager 1322 may be substantially similar to forecast manager 1024 of FIG. 10, so is not discussed in detail in this Part 13. Each forecast valuation is generated relative to a specific point in time within the guarantee period, and is stored in memory 151. For example, different forecasted valuations (and DVs) may be generated for a subject property at different points in time out up to 3 years or more, e.g., 6 months, 1 year, 18 months, 2 years and so on.

A DV is preferably the estimated value of the property if sold at foreclosure at a given point of time, or within a given period of time. Although, it is possible that a DV may be determined according to some other pre-selected threshold (i.e., not at foreclosure, such as foreclosure+10% or automated valuation−10%). The DV may be determined in any of a variety of manners using, for example, math modeling or statistical analysis techniques known to those skilled in the art. For example, a current DV may be determined or estimated by DV manager 1312 using past foreclosure comparable sales data and comparing that data to automated property valuations for the same subject properties. Forecast manager 1322 may then forecast DVs for the guarantee period, or for one or more points of time therein. That is, DV manager 1312 may task forecast manager 1322 to forecast DVs using a set of algorithms that analyze and estimate the likely DVs in a given market, at a given point in time for that type (e.g., single family home, and so on) of property when sold at default (e.g., such as at auction). Preferably, but not essentially, the DV is determined as a function of the property valuation, such that the DV is discounted from the estimated automated valuation (at a given point in time).

In the preferred embodiment, DV manager 1312 of the PVG application 1300 determines or accesses one or more default correction factors, to be applied to property valuations. A default correction factor may be determined in any of a variety of manners, but is preferably accomplished by looking at historical data on past foreclosure sales for homes similar to the subject property in that geographic area and comparing those foreclosure sale prices to the retrospective automated property valuations as of the time of the foreclosure sales. In one form, DV manager 1312 may derive a constant default correction factor of 0.80 (or 80% of automated valuation), for example, from historical foreclosure data to be applied generally to properties in that region, no matter the type of property or the point in time. So, forecasted property valuations could always be multiplied by 0.80 (in this example) to arrive at a forecasted DV at that point in time that relates to the forecasted property valuation. This constant default correction factor could be updated as time passes and more historical foreclosure data is obtained. As a variation, a default correction factor may be defined for each property type (i.e., single family homes, condominiums, or cooperatives, non-residential) and/or for each market, market segment, or market type (e.g., urban, suburban).

Like property valuations and DVs, default correction factors could also be forecasted by forecast manager 1322, using historical foreclosure sales data. Also like automated valuations and DVs, default correction factors may be forecasted at selected points in time (e.g., each month within the guarantee period) or for a period of time (e.g., a different DV for each year of guarantee period). The historical sales data may be used to determine trends which allow predictions (or forecasts) to be made at future points in time, using known predictive math models and techniques. According to trend or statistical analysis, default correction factors may be determined at selected points in time or for a given period of time.

As previously mentioned, forecasted DVs may be determined by determining a current which could be accomplished by applying a default correction factor to a current automated property valuation, and then forecasting DVs from the current DV using forecast manager 1322. Therefore, this approach does not use forecasted valuations to forecast DVs. In another form, the DV manager 1312 may apply a default correction factor to discount forecasted valuations to arrive at a forecasted DVs, at selected point of time or period of time. As an example, assume the subject property is a single family home, 3 bedrooms, 1.5 baths in Lexington, Mass. The following forecasted valuations may be determined:

TABLE 13-1

| | 6 | 12 | 18 | 24 | 30 | 36 |
|---|---|---|---|---|---|---|
| Period: | months | months | months | months | months | months |
| Val: | $200 K | $205 K | $205 K | $210 K | $212 K | $215 K |

The timeframes (i.e., 6 months, 12 moths and so forth) may be given from the query date or from the planned (or actual) date of closing the loan, as examples. Other dates may be used as starting points. Assuming a constant default correction is not used, but rather a default correction factor is forecasted at each 6 month point (or for each 6 month period), the default correction factors may be determined as follows:

TABLE 13-2

| | 6 | 12 | 18 | 24 | 30 | 36 |
|---|---|---|---|---|---|---|
| Period: | months | months | months | months | months | months |
| Val: | $200 K | $205 K | $205 K | $210 K | $212 K | $215 K |
| Factor: | 0.80 | 0.81 | 0.80 | 0.79 | 0.81 | 0.80 |

In this example, applying the default correction factors to the forecasted valuations may yield the following DVs:

TABLE 13-3

| | 6 | 12 | 18 | 24 | 30 | 36 |
|---|---|---|---|---|---|---|
| Period: | months | months | months | months | months | months |
| Val: | $200 K | $205 K | $205 K | $210 K | $212 K | $215 K |
| | 0.80 | 0.81 | 0.80 | 0.79 | 0.81 | 0.80 |
| DV: | $160 K | $166.05 K | $164 K | $165.9 K | $171.72 K | $172 K |

In this case, the DV at 12 months, using the default correction factor of 0.81, may represent a guaranteed DV for 0 to 12 months. Otherwise, the DV at 12 months of $166.05K may be the DV from month 6 to month 12, while the DV at month 6 of $160K may be the DV for months 0-6, as examples.

If a constant default correction factor is used, such as 0.80, the following would result:

TABLE 13-4

| | 6 | 12 | 18 | 24 | 30 | 36 |
|---|---|---|---|---|---|---|
| Period: | months | months | months | months | months | months |
| Val: | $200 K | $205 K | $205 K | $210 K | $212 K | $215 K |
| Factor: | 0.80 | 0.80 | 0.80 | 0.80 | 0.80 | 0.80 |
| DV: | $160 K | $164 K | $164 K | $168 K | $169.6 K | $172 K |

In either case, the lender may then procure a guarantee (or insurance policy) to insure a minimum DV. In one example, the lender may choose to buy a guaranteed minimum DV for a given timeframe, e.g., 1 year, 2 years and so on. Table 13-3 may be interpreted in at least three ways. First, Table 13-4 may be interpreted such that a minimum DV of $172K may be procured for the entire 36 month period. Second, the lender may choose in insure at the minimum DV for the 36 month period (i.e., at a DV=$160K). Third, Table 13-3 may interpreted as a schedule of DVs over a period (e.g., 36 months) wherein the lender may buy a guarantee DV according to the schedule depicted Table 13-3 above. In this latter case, if a lender buys a guarantee for 18 months, the lender is guaranteed a DV of $160K from months 0 to month 6, a DV of $166.05K from month 6 to month 12, and a DV of $164K from month 12 to month 18. Of course, Table 13-4 could also be interpreted in either of these three manners.

Returning to FIG. 13, the guarantee account manager 1320 establishes and manages a guarantee (or insurance) policy, once the lender selects its coverage. The account may be established in DB 151. In the event of a default and claim, a claim manager 1316, of PGV application 1300, access accesses the lender's policy information and, given the date of default, determines the applicable DV. Claim manager 1316 also requires the foreclosure sale price (or realized default value) of the subject property, which may be input as part of the claim process or may be obtained from a third party system 130. Preferably, the guarantor receives some independent confirmation of the realized default value. The applicable DV and realized default value are passed to a payment manager 1314, which determines the existence and magnitude of a shortfall. The shortfall amount is preferably the claim payment amount. A basic claim payment formula is:

payment amount=guaranteed DV−realized default value,

Payments may be accomplished via electronic funds transfer or via production of a check, as examples.

As a result, with reference Table 13-3, if a lender insures through 24 months for a DV of $165.9K for the 24 month period, that lender is guaranteed that if the subject property is sold in default during that 24 month period for an amount less than $165.9K, the lender will not lose the difference. Therefore, if the subject property sold for $160K at a foreclosure auction, the lender would recover $5.9K from the guarantor. The guarantor may cap the amount of guarantee to protect against severe downturns in the market or property specific is factors that may influence the subject property's foreclosure sale price.

As will be appreciated by those skilled in the art, while the system is described with respect to a lender getting the benefit of an insurance policy, others may also benefit from such guarantees and policies, including other lien holders, or perhaps the property owner.

Part 14. Comprehensive System and Method

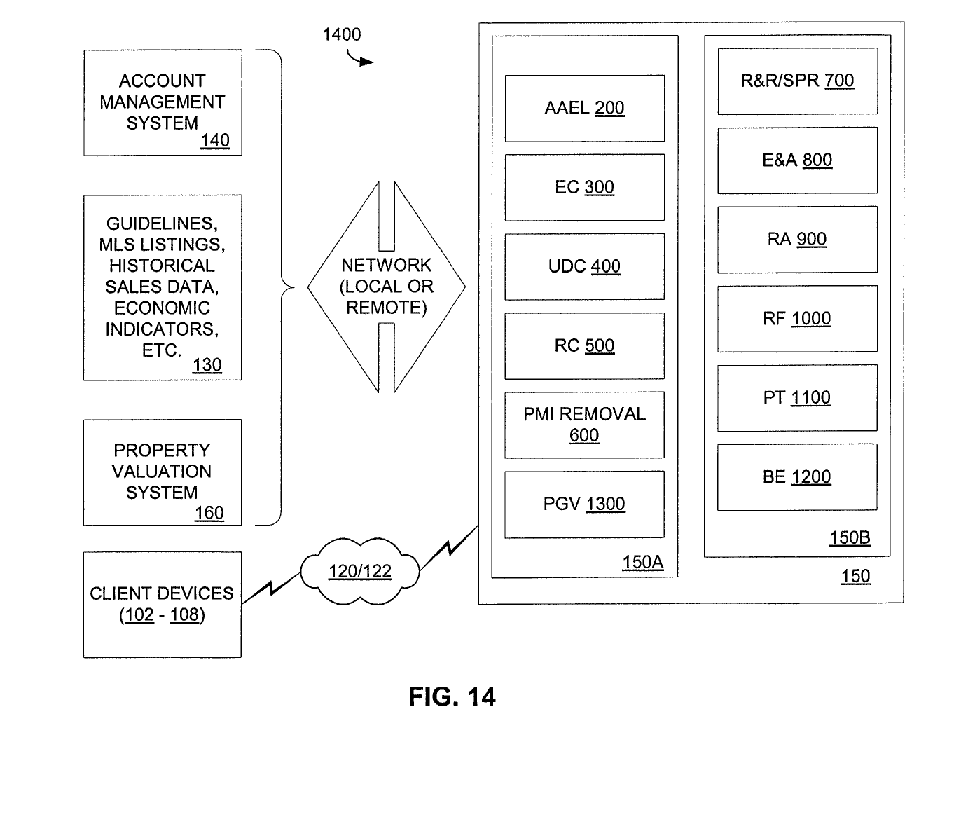

FIG. 14 depicts a comprehensive system 1400 and method in accordance with the present invention, wherein the various modules (or application programs) described in Parts 1 through 13 are combined into application system 150. Modules most closely related to mortgage loans and equity loans are grouped in set 150A. Modules most closely related to the searching and/or listing of properties are grouped in set 150B. As previously discussed, these modules may be variously distributed onto other systems and their functionality is preferably accessible via a network, such as the Internet and Web.

While the present invention is described with respect to individual buyers or sellers of residential real property, it should be appreciated that the present invention could be applied in a variety of contexts, for example, where the real property is commercial property and the owner is a business entity (e.g., a corporation or a partnership). Additionally, regardless of the type of real property, non-commercial or commercial, the owner could be a trust, estate, corporation, partnership, government or educational institution, as examples. Furthermore, the system may be implemented for other types of property, such as personal property (e.g., cars, boats, antiques and other collectibles, equity accounts and so on) or property owned by a business entity (e.g., equipment, accounts receivable, intellectual property). In fact, the system could be implemented to include combinations of the above types of ownership interests and types of property.

The invention may be embodied in other specific forms without departing from the spirit or central characteristics thereof. The present embodiments are therefore to be considered in all respects as illustrative and not restrictive, the scope of the invention being indicated by appending claims rather than by the foregoing description, and all changes that come within the meaning and range of equivalency of the claims are therefore intended to be embraced therein.

What is claimed is:

1. A property rating system comprising:
A. a set of data systems comprising listings of real properties for sale, wherein each listing includes a set of parameters, said parameters including an address, a property type, and a list price;
B. a property valuation system configured to generate a property valuation for a subject property, as a function of said parameters; and
C. a rating module, hosted on a computer device having access to said set of data systems and said property valuation system, said rating module including:
1) a user interface configured to accept a client's input of a set of candidate property criteria;
2) a valuation manager configured to query said set of data systems for a list of candidate properties having parameters substantially satisfying said candidate property criteria and to query said property valuation system for a property valuation for each candidate property; and
3) a rating manager configured to rate each candidate property as a function of a set of rating criteria, wherein said rating criteria include a rating criterion related to a comparison of said list price to said property valuation for a candidate property.

2. A rating system as in claim 1, wherein a set of industry ratings are defined and said rating criteria are institutionalized rating criteria corresponding to said industry ratings.

3. A rating system as in claim 1, wherein said at least some of said rating criteria are client defined rating criteria.

4. A rating system as in claim 1, wherein said comparison of said list price to said property valuation for a candidate property is represented in the form of a ratio of said list price to said property valuation.

5. A rating system as in claim 1, wherein said rating manager is configured to weight one or more rating criterion from said rating.

6. A rating system as in claim 5, wherein said rating manager is configured to determine the weight of said at least one rating criterion as a function of one or more of a set of client inputs or a set of client responses to prompts provided via said rating system.

7. A rating system as in claim 1, wherein said rating system is accessible via a plurality of wired and wireless network types by a plurality of types of wired and wireless client devices.

8. A rating system as in claim 7, wherein said plurality of types of client devices include one or more of:
A. a personal computer;
B. a workstation;
C. a personal digital assistant;
D. a Web enabled television or appliance; and
E. a cellular or standard telephone.

9. A rating system as in claim 7, where said plurality of network types include one or more of:
A. a LAN, WAN, or VPN;
B. an intranet;
C. an extranet;
D. Internet and Web; and
E. a cellular or a standard telephone network.

10. A rating system as in claim 1, wherein said user interface is a Web site interface.

11. A rating system as in claim 1, wherein said listings of real properties are listings of residential real estate properties, and said set of parameters further includes one or more of:
A. number of bedrooms,
B. number of bathrooms,
C. square footage;
D. lot size;
E. year built;
F. amount of annual real estate taxes; and
G. proximity to schools or public transportation.

12. A rating system as in claim 1, wherein said listings of real properties are listings of residential real estate properties, and property type is chosen from a group of property types including:
A. single family home;
B. multi-family home;
C. townhouse;
D. condominium; and
E. cooperative.

13. A rating system as in claim 1, wherein the list price for each candidate property is editable by the client and wherein said rating manager is configured to rate one or more of said candidate properties having an edited list price or minimum or maximum list price.

14. A rating system as in claim 1, further comprising:
D. a ranking manager configured to rank each of said rated candidate properties as a function of a set of ranking criteria.

15. A rating system as in claim 14, wherein said ranking criteria are client defined or selected ranking criteria.

16. A rating system as in claim 14, wherein said ranking manager is configured to weight one or more ranking criterion from said ranking criteria.

17. A method of rating property comprising:
A. inputting by a client a set of candidate property criteria to a rating system;
B. comprising a list of candidate properties, including:
1) querying a set of data systems comprising listings of real properties for sale, wherein each listing includes a set of parameters, said parameters including an address, a property type, and a list price; and
2) returning a list of candidate properties having parameters substantially satisfying said candidate property criteria; and
C. obtaining a property valuation for each candidate property from said list of candidate properties by querying a property valuation system; and
D. rating each candidate property as a function of a set of rating criteria, wherein said rating criteria include a rating criterion related to a comparison of said list price to said property valuation for a candidate property.

18. The method of claim 17, wherein a set of industry ratings are defined and said rating criteria are institutionalized rating criteria corresponding to said industry ratings.

19. The method of claim 17, wherein Part D includes defining, by said client, at least some of said rating criteria.

20. The method of claim 17, wherein said comparison of said list price to said property valuation for a candidate property includes forming a ratio of said list price to said property valuation.

21. The method of claim 17, wherein Part D includes weighting at least one of said rating criteria.

22. The method of claim 21, wherein said weighting of said at least one rating criteria is determined by said rating manager as a function of one or more of a set of client inputs or a set of client responses to prompts provided via said rating system.

23. The method of claim 17, wherein said client inputting is accomplished via a wired or wireless network enabled client device and at least two of said client device, said set of data systems, said property valuation systems and said rating system are coupled via a network.

24. The method of claim 17, wherein said listings of real properties are listings of residential real estate properties, and said set of parameters further includes one or more of:
A. number of bedrooms,
B. number of bathrooms,
C. square footage;
D. lot size;
E. year built;
F. amount of annual real estate taxes; and
G. proximity to schools or public transportation.

25. The method of claim 17, wherein said listings of real properties are listings of residential real estate properties, and property type is chosen from a group of property types including:
A. single family home;
B. multi-family home;
C. townhouse;
D. condominium; and
E. cooperative.

26. The method of claim 17, wherein the list price for each candidate property is editable by the client and wherein part D includes editing a list price of a selected candidate property and rating said selected candidate property.

27. The method of claim 17, further comprising:
E. ranking said rated candidate properties as a function of a set of ranking criteria.

28. The method of claim 28, wherein Part E includes weighting at least one of said ranking criteria.

29. The method of claim 17, wherein said user interface is a Web site interface.

30. A real property rating and ranking system comprising:
A. a set of data systems comprising listings of real properties for sale, wherein each listing includes a set of parameters, said parameters including an address, a property type, and a list price;
B. a property valuation system configured to generate a property valuation for a subject property, as a function of said parameters;
C. a rating module, hosted on a computer device having access to said set of data systems and said property valuation system, said rating module including:
1) a user interface configured to accept a client's input of a set of candidate property criteria;
2) a valuation manager configured to query said set of data systems for a list of candidate properties having parameters substantially satisfying said candidate property criteria and to query said property valuation system for a property valuation for each candidate property; and
3) a rating manager configured to rate each candidate property as a function of a set of rating criteria, wherein said rating criteria include a rating criterion related to a comparison of said list price to said property valuation for a candidate property; and
D. a ranking manager configured to rank each of said rated candidate properties as a function of a set of ranking criteria.

31. A rating and ranking system as in claim 30, wherein said rating manager is configured to weight one or more rating criterion from said rating.

32. A rating and ranking system as in claim 30, wherein a set of industry ratings are defined and said rating criteria are institutionalized rating criteria corresponding to said industry ratings.

33. A rating and ranking system as in claim 30, wherein said ranking manager is configured to weight one or more ranking criterion from said ranking criteria.

34. A rating and ranking system as in claim 30, wherein said user interface is a Web site interface.

35. A method of rating and ranking real property, comprising:
A. inputting by a client a set of candidate property criteria into a rating and ranking system;
B. comprising a list of candidate properties, including:
1) querying a set of data systems comprising listings of real properties for sale, wherein each listing includes a set of parameters, said parameters including an address, a property type, and a list price; and
2) returning a list of candidate properties having parameters substantially satisfying said candidate property criteria; and
C. obtaining a property valuation for each candidate property from said list of candidate properties by querying a property valuation system;
D. rating each candidate property as a function of a set of rating criteria, wherein said rating criteria include a rating criterion related to a comparison of said list price to said property valuation for a candidate property; and
E. ranking said rated candidate properties as a function of a set of ranking criteria.

36. A method of claim 35, further comprising weighting one or more rating criterion from said rating criteria.

37. A method of claim 35, further comprising weighting one or more ranking criterion from said ranking criterion.

38. A ranking system comprising:
A. a set of data systems comprising listings of real properties for sale, wherein each listing includes a set of parameters, said parameters including an address, a property type, and a list price;
B. a property valuation system configured to generate a property valuation for a subject property, as a function of said parameters;
C. a rating module, hosted on a computer device having access to said set of data systems and said property valuation system, said rating module including:
1) a user interface configured to accept a client's input of a set of candidate property criteria;
2) a valuation manager configured to query said set of data systems for a list of candidate properties having parameters substantially satisfying said candidate property criteria and to query said property valuation system for a property valuation for each candidate property; and
3) a ranking manager configured to rank each of said candidate properties as a function of a set of ranking criteria, wherein said ranking criteria include a ranking criterion related to a comparison of said list price to said property valuation for a candidate property.

39. A ranking system as in claim 38, wherein said ranking manager is configured to weight one or more ranking criterion from said ranking criteria.

40. A ranking system as in claim 38, wherein said user interface is a Web site interface.

41. A ranking system as in claim 38, wherein said listings of real properties are listings of residential real estate properties, and said set of parameters further includes one or more of:
A. number of bedrooms,
B. number of bathrooms,
C. square footage;
D. lot size;
E. year built;
F. amount of annual real estate taxes; and
G. proximity to schools or public transportation.

42. A ranking system as in claim 38, wherein said listings of real properties are listings of residential real estate properties, and property type is chosen from a group of property types including:
A. single family home;
B. multi-family home;
C. townhouse;
D. condominium; and
E. cooperative.

43. A ranking system as in claim 38, wherein the list price for each candidate property is editable by the client and wherein said ranking manager is configured to rank said candidate properties, wherein one or more selected candidate properties have an edited list price.

44. A ranking system as in claim 38, wherein said ranking manager is configured to determine the weight of said at least one ranking criterion as a function of one or more of a set of client inputs or a set of client responses to prompts provided via said ranking system.

45. A ranking system as in claim 38, wherein said ranking system is accessible via a plurality of wired and wireless network types by a plurality of types of wired and wireless client devices.

46. A ranking system as in claim 45, wherein said plurality of types of client devices include one or more of:
A. a personal computer;
B. a workstation;
C. a personal digital assistant;
D. a Web enabled television or appliance; and
E. a cellular or standard telephone.

47. A ranking system as in claim 45, where said plurality of network types include one or more of:
A. a LAN, WAN, or VPN;
B. an intranet;
C. an extranet;
D. Internet and Web; and
E. a cellular or a standard telephone network.
